(19) United States
(12) Patent Application Publication
(10) Pub. No.: US 2012/0084064 A1
(43) Pub. Date: Apr. 5, 2012

(54) Model-based systems and methods for analyzing and predicting outcomes of vascular interventions and reconstructions

(75) Inventors: Yuris Dzenis, Lincoln, NE (US); Alexey Kamenskiy, Lincoln, NE (US); Iraklis Pipinos, Omaha, NE (US); Jason N. MacTaggart, Omaha, NE (US)

(73) Assignee: NUtech Ventures, Inc., Lincoln, NE (US)

(21) Appl. No.: 13/200,719

(22) Filed: Sep. 29, 2011

Related U.S. Application Data
(60) Provisional application No. 61/387,775, filed on Sep. 29, 2010.

(51) Int. Cl. G06G 7/60

(52) U.S. Cl. 703/11

(57) ABSTRACT

Systems and methods for analyzing and predicting treatment outcomes of medical procedures such as vascular interventions and reconstructions are disclosed. An illustrative system for analyzing and predicting therapeutic outcomes of medical procedures comprises a relational database configured for classifying and storing patient specific input data for multiple patients, a fluid-solid interaction biomechanical model configured for performing a biomechanics simulation and generating biomechanics data, and a graphical user interface.

### CROSS-REFERENCE TO RELATED APPLICATION

This application claims priority to U.S. Provisional Application No. 61/387,775, entitled “Method For Selection of Patches For use In Vascular Interventions and Reconstructions,” filed on Sep. 29, 2010, the contents of which are incorporated herein by reference in their entirety for all purposes.

### STATEMENT REGARDING FEDERALLY SPONSORED RESEARCH OR DEVELOPMENT

This invention was made with government support under NSF grant EPS-0701892. The government has certain rights in the invention.

### TECHNICAL FIELD

The present disclosure relates generally to systems and methods for analyzing and predicting outcomes of vascular interventions, reconstructions, and other medical procedures.

### BACKGROUND

Cardiovascular disease is the failure of the circulatory system to supply adequate amounts of blood to organs and tissue. Cardiovascular disease affects more than eighty million people in the United States alone, and is the single leading cause of death and disability for both men and women in the developed world. In many cases, cardiovascular disease is caused by atherosclerosis, or the narrowing of the arteries due to fatty build ups called atheromatous plaques. These plaques can also include scar tissue, cholesterol, calcium, and other substances contained in the blood.

In severe cases of the disease, reestablishment of blood flow in narrowed or blocked arteries can only be achieved with vascular interventions and reconstructions. Among blood vessels frequently repaired are the carotid, aortoilliac, peripheral, mesenteric, renal, and arm arteries. The surgical and interventional procedures used to treat severely affected blood vessels can be classified as either open or endovascular surgery. The former can be in the form of a bypass surgery involving synthetic or natural grafts or an endarterectomy procedure in which the atherosclerotic plaque is surgically removed through an incision on the side of the blood vessel. Endarterectomy procedures often involve the use of a patch of natural or synthetic material to close the incision formed in the vessel wall in order to maintain proper blood flow. Angioplasty is a minimally invasive, catheter-based vascular technique in which a small balloon is inflated inside a narrowed blood vessel, opening up the vessel for improved blood flow. After the angioplasty, a mesh-like stent is frequently deployed in the vessel to maintain long-term patency of the vessel after the procedure.

Other vascular diseases that can be treated with surgical procedures involving vascular grafts include abdominal and thoracic aortic aneurysms and peripheral arterial aneurysms (e.g., poplietal, femoral, carotid, arm, or visceral aneurysms). For aortic aneurysms, synthetic or natural grafts are typically used in the repair of the affected vessels. For peripheral aneurysms, bypass or replacement procedures are typically used. Endovascular stent-grafts or covered stents are sometimes used in the minimally invasive treatment of aneurysms.

Many of the treatment techniques used for treating cardiovascular disease have been shown to increase life expectancy and decrease the length of hospitalization and postoperative care. For example, endarterectomy procedures used for treating the carotid artery have been shown to reduce the risk of stroke in patients with moderate and high-grade symptomatic and high-grade asymptomatic carotid bifurcation stenoses. Cartoid endarterectomy followed by patch angioplasty has also been shown to decrease the incidence of early and late complications associated with the performance of carotid endarterectomy. A variety of synthetic and biological patches have been developed and are available for endarterectomy procedures. Alternatively, a variety of stents and stent-graft are also available.

One complication associated with some surgical and interventional procedures is the postoperative restenosis of the reconstructed vessel. Restenosis often starts as neointimal hyperplasia or abnormal growth of new tissue over or near the graft or stent. This is often followed by new atherosclerotic plaque build-up near or inside the graft or stent. Restenosis affects as many as 20 to 30 percent of all arterial reconstructions, and in some instances can affect a greater percentage of patients depending on the type of blood vessel being repaired and the characterization of the restenosis. Both neointimal hyperplasia and atherosclerosis have been linked to various forms of insult to the arterial wall. Such insult may be produced by the increased stresses and injury in reconstructed or treated blood vessels or by the atherogenic influence of the flow and oscillatory wall shear stress in the blood flow. Another possible complication is the mechanical failure of stents or stent-grafts.

The mechanical factors leading to restenosis or device failure cannot be imaged or measured using existing experimental techniques. However, they can be predicted using biomechanics modeling. The problem of accurately predicting these disease-related mechanical and flow factors in surgically repaired blood vessels is a complex non-linear fluid-solid interaction problem. The outcomes highly depend on the large number of inputs and data that are known to vary broadly based on the individual characteristics of the patient, stage and type of disease, and multiple other conditions. Currently, there are no known systems or methods to systematically evaluate, visualize, and optimize these mechanical and flow factors as a result of the reconstruction or treatment. Such optimization, however, could decrease the incidence of neointimal hyperplasia and atherosclerosis by selecting an appropriate medical device or a suitable course of treatment for a particular patient or group of patients. The optimization based on predictive modeling could also lead to new and improved repair materials and devices.

### SUMMARY

The present disclosure relates generally to model-based systems and methods for analyzing and predicting outcomes of vascular interventions, reconstructions, or other medical procedures.

An illustrative method for analyzing and predicting treatment outcomes of vascular interventions and reconstructions comprises: inputting patient specific data associated with a patient into a database; searching the database and obtaining additional data to be associated with the patient, wherein the additional data is obtained based at least in part on patient specific data stored within the database for one or more other patients; selecting at least one of a treatment parameter or medical device parameter to be used in association with a proposed treatment option for treating the patient; searching the database and obtaining one or more model properties associated with the treatment or medical device parameter; generating a fluid-solid interaction biomechanical model based at least in part on the patient specific data, the additional data associated with the patient, and the model properties; performing a biomechanics simulation and generating biomechanics data using the biomechanical model; and analyzing the biomechanics data.

An illustrative system for analyzing and predicting therapeutic outcomes in medical procedures comprises: a relational database configured for classifying and storing patient specific input data for a plurality of patients; a means for obtaining and inputting patient specific input data to the database; a means for selecting additional data to be associated with the patient in the database; a means for inputting treatment related and medical device related parameters to the database; a means for selecting treatment type, inputting model parameters, and assembling a biomechanical model based on the selected treatment type, the patient specific data, the additional data associated with the patient, and the treatment and medical device related parameters; a processor and fluid-solid interaction biomechanical model configured for performing a biomechanics simulation and generating biomechanics data, the fluid-solid biomechanical model comprising time-dependent, three-dimensional solid and fluid equations; a means for evaluating the outcomes of the biomechanics simulation; and an interface configured for exchanging data between the database and a plurality of users.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic view of a model-based system for analyzing and predicting outcomes of vascular interventions and reconstructions in accordance with an illustrative embodiment;

FIG. 2 is a schematic view showing several example input parameters for use by the mechanical properties evaluation module of FIG. 1 in analyzing biological materials and anatomical structures;

FIG. 3 is a schematic view showing several example input parameters for use by the mechanical properties evaluation module of FIG. 1 in analyzing the behavior of synthetic grafts;

FIG. 4 is a schematic view showing several example input parameters for use by the mechanical properties evaluation module of FIG. 1 in analyzing the behavior of stents;

FIG. 5 is a schematic view showing several example input parameters for use by the blood rheology evaluation module of FIG. 1 in analyzing rheological behavior of blood;

FIG. 6 is a schematic view showing several example input parameters for use by the blood vessel geometry evaluation module of FIG. 1 in analyzing the geometry of blood vessels or vessel reconstructions;

FIG. 7 is a schematic view showing several example input parameters for use by the medical device geometry evaluation module of FIG. 1 in analyzing the geometry of medical devices such as grafts and stents;

FIG. 8 is a schematic view showing several example input parameters for use by the boundary blood flow evaluation module of FIG. 1 in analyzing blood flow;

FIG. 9 is a schematic view showing several example input parameters for use by the load evaluation module of FIG. 1 in analyzing dynamic and static loads exerted on blood vessels, reconstructions, or other anatomical structures;

FIGS. 10a-10b are example plots showing posterior and anterior three-dimensional visualizations of blood vessel stresses that can be generated by the graphical user interface of FIG. 1;

FIG. 11 is a schematic view showing an example software platform for use with the system of FIG. 1;

FIG. 12 is a flow diagram of an example method for analyzing and predicting treatment outcomes of vascular interventions and reconstructions;

FIG. 13 is a flow diagram of another example method for analyzing and predicting treatment outcomes of a medical procedure such as a patch endarterectomy procedure;

FIG. 14 is a flow diagram of an example method for analyzing a medical device design for a group of patients;

FIG. 15 is a flow diagram of an example method for analyzing a medical device design for a specific patient;

FIG. 16 is a schematic view of three-dimensional mean carotid artery geometry generated for a group of sixteen patients;

FIGS. 17a-17e are several plots showing the comparison of different surgical reconstruction techniques in terms of atherosclerosis-related mechanical parameters such as effective stress expressed in logarithmic values;

FIG. 18a-18b are several plots showing complex, three-dimensional pulsatile velocity profiles in an internal carotid artery (ICA) and external carotid artery (ECA), respectively;

FIGS. 19a-19b are several plots showing zones of blood flow recirculation and stagnation in a carotid bulb for systole and diastole, respectively;

FIGS. 20a-20b are several plots showing a three-dimensional visualization of overlapping stents deployed in a superficial femoral artery, in which high stress concentrations are shown on the arterial wall along with the presence of atherosclerotic plaque;

FIGS. 21a-21b are several plots showing the three-dimensional visualization of a carotid artery before and after angioplasty and stenting, respectively; and

FIGS. 22a-22b are several plots showing the presence of zones of high stress concentrations in the arterial wall, plaque, and stent struts.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

Model-based systems and methods that utilize patient-specific physiological data and/or previously acquired data from other, similarly situated patients or cases can be used to analyze, and in some cases predict, various parameters for determining a suitable course of treatment for a patient. These systems and methods can also be used as a tool for selecting medical devices tailored to a patient's particular medical condition, or for developing new medical devices. In some embodiments, the patient-specific and/or previously acquired input data can be classified and stored in one or more computer databases that can be accessed by individuals over a computer or computer network. For example, the database or databases can be accessed by health care professionals over the Internet to perform preoperative or intraoperative evaluations of possible treatment options and/or to optimize a particular treatment plan, thus improving the clinical decision-making process and overall treatment outcome decisions. The database can also be used by medical device developers for researching and developing new medical devices and treatments.

In certain embodiments, the systems and methods can be used in open or endovascular surgery procedures in the treatment of cardiovascular diseases, including coronary artery disease, carotid artery disease and aortoilliac, peripheral, mesenteric, renal, and arm artery stenoses. The systems and methods can also be used in the treatment of various forms of arterial aneurysms, including abdominal and thoracic aortic aneurysms and peripheral arterial aneurysms (e.g., poplietal, femoral, carotid, arm, or visceral aneurysms) treated by repair, bypass, replacement, or endovascular stent-grafting. The systems and methods can also be used for developing new medical devices, or for developing medical devices customized for use in a particular patient or groups of patients.

The systems and methods disclosed herein can be implemented in hardware, software, or a combination of both. In some embodiments, the systems and methods can be executed as computer readable instructions on a programmable computer or processor comprising a data storage system with volatile and/or non-volatile memory. Although various example systems and methods are described herein with respect to vascular interventions and reconstructions, the systems and methods can be used to analyze and model other types of physiological conditions and can be used to evaluate other treatment options or to develop other types of medical devices. In some cases, the systems and methods can also be used to evaluate and predict possible medical device failures.

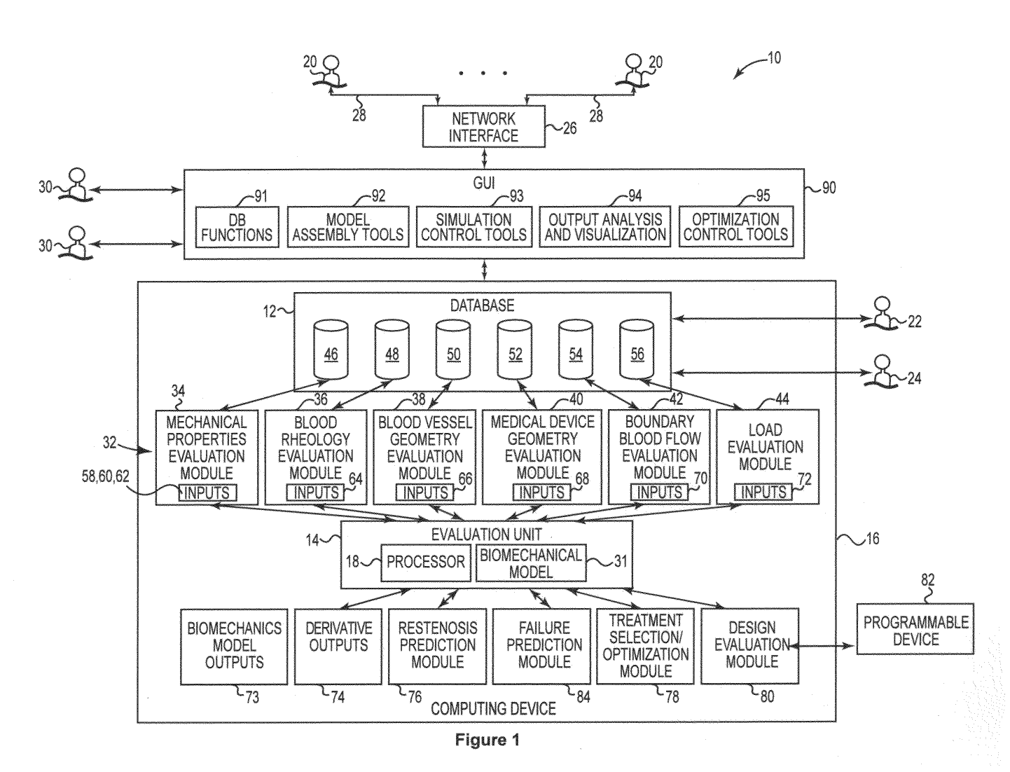

FIG. 1 is a schematic view of a model-based system 10 for analyzing and predicting outcomes of vascular interventions and reconstructions in accordance with an illustrative embodiment. The system 10 comprises a relational database 12 and an evaluation unit 14 operable on a computing device 16 such as a server, personal computer, or hand-held computing device. In some embodiments, the computing device 16 includes software and/or hardware functionality capable of executing various computer instructions via a processor 18. Although the database 12 and evaluation unit 14 are shown as part of a single, integral computing device 16 in FIG. 1, in other embodiments one or more components of the system 10 can be distributed across multiple computing devices or can be combined into a single unit.

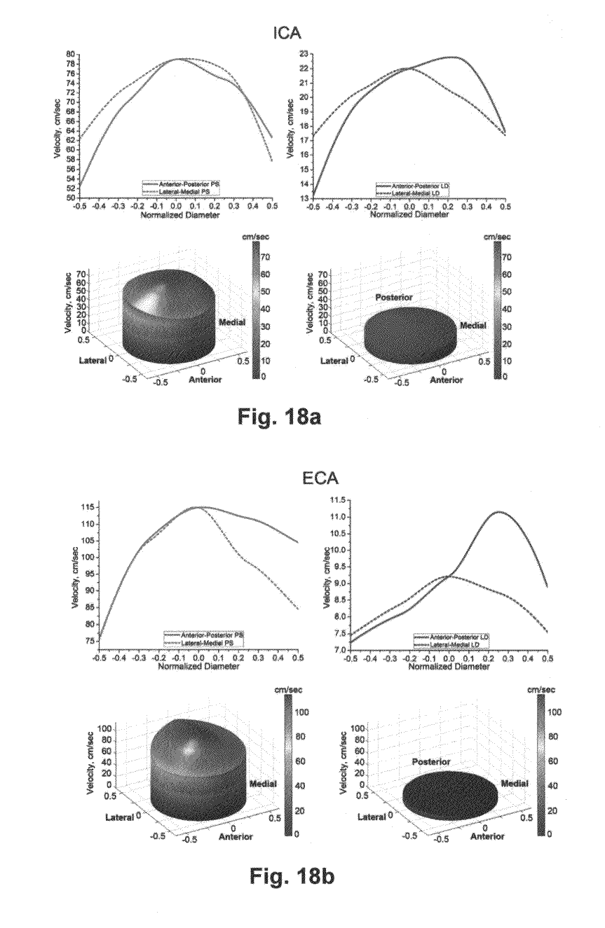

The database 12 is configured to store data inputted to the system 10 by one or more users 20, 30. In some embodiments, for example, the database 12 is configured to store raw and/or processed data associated with a group of current patients 22 to be treated or other individuals 24 such as past patients or cadavers. For example, the database 12 can be configured to store data obtained from an imaging procedure such as Magnetic Resonance Angiography (MRA) or Computerized Tomographic Angiography (CTA). The database 12 can also be configured to store simultaneous electrocardiogram (ECG) recordings, recordings of blood flow evaluations and other physiologic data acquired from the patients 22, 24. Examples of velocity data to be stored in the database and an example three-dimensional graphical representation of such data is shown, for example, in FIGS. 18a-18b. Data relating to mechanical properties of materials such as blood vessel wall plaque and properties of patching materials, stents and/or stent-grafts can also be collected and inputted as data to the database 12.

Other input data such as patient age, gender, race, cardiovascular risk factor profile, clinical history, medications, blood count, diet, lifestyle, as well as other clinical laboratory measurements can also be inputted to and stored within the database 12. Typically, the type and format of the information inputted to the database 12 will vary depending on the type of patient, the patient's condition, the treatment options available for treating the patient, as well as other factors. In some embodiments, the database 12 contains average parameters computed for a particular patient or group of patients. In some embodiments, for example, the database 12 contains mean three-dimensional geometric data of a particular type of vessel (e.g., a carotid artery) computed from multiple patients.

The database 12 is expandable and scalable, allowing for the addition of new data such as tissue histology, tissue models, medical devices, and newly discovered medical record data. In some embodiments, the database 12 is implemented using a combination of relational and non-relational database schemas, allowing disparate data formats inputted by the users 20, 30 to be integrated into a unified database 12 that can be accessed by other system users 20, 30.

In the embodiment of FIG. 1, the database 12 and evaluation unit 14 are accessible by one or more users 20 over a network interface 26 with multiple network access portals 28. In certain embodiments, for example, the network access portals 28 comprise Internet or intranet portals that can be accessed by users 20 over a computer. The database 12 and evaluation unit 14 can also be accessed directly (e.g., off-line) by some users 30 such as software end-users or a network administrator. The level of database access and functionality may vary depending on the type of user 20, 30. For example, users 20, 30 such as health care professionals may be provided with security credentials greater than other users 20, 30, allowing these professionals to access confidential information about a specific patient or group of patients 22, 24. In contrast, other users 20, 30 such as researchers or medical device developers may be given more limited access credentials to the database 12 in order to maintain patient confidentiality and anonymity.

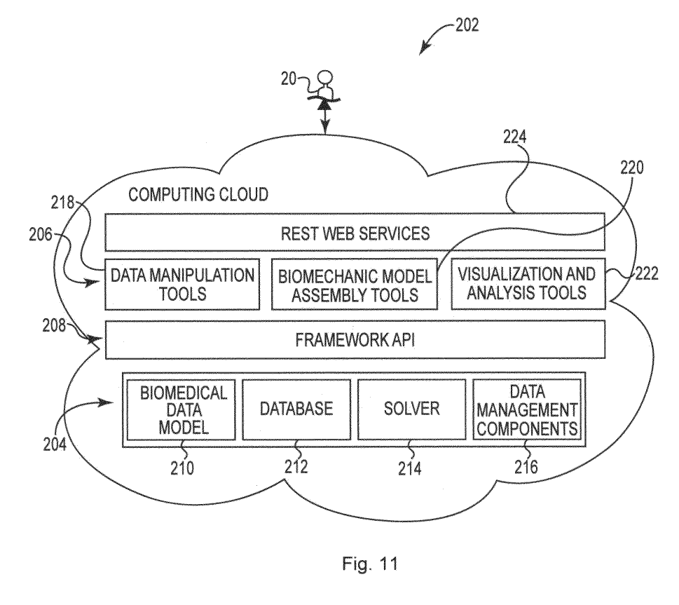

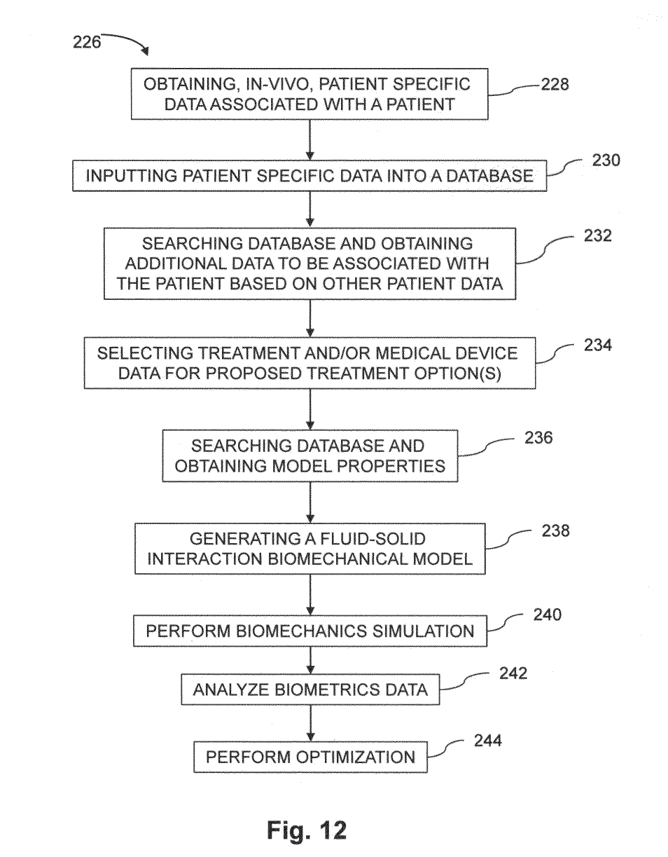

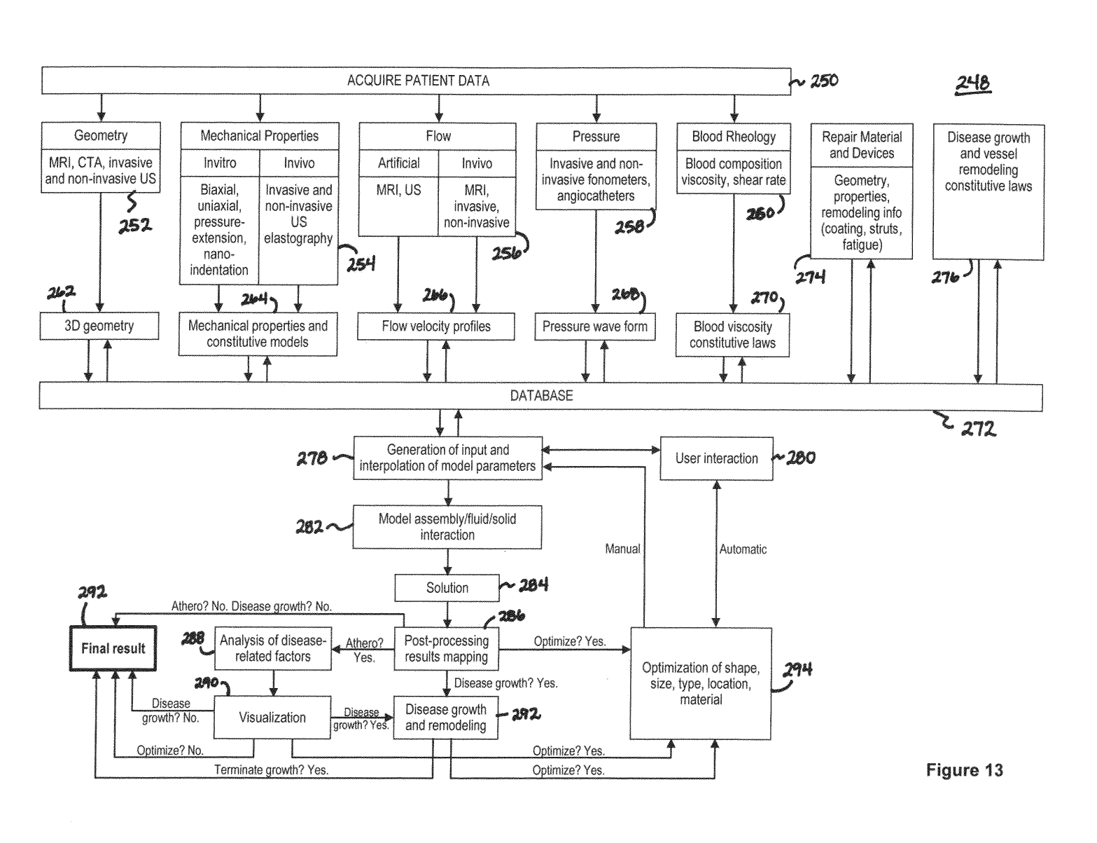

The processor 18 is configured to run an algorithm or routine that combines data acquired from one or multiple evaluation modules 32 and generates various output parameters that can be used by the processor 18 and a biomechanical model 31 to analyze, and in some cases predict, various patient-based treatment outcomes associated with the use of a particular reconstruction technique or medical device. In the embodiment of FIG. 1, the algorithm or routine comprises a coupled fluid-solid interaction biomechanical model 31 that uses, as model inputs, data that is measured and/or gathered by one or more of the evaluation modules 32. Based on these model inputs, the biomechanical model 31 determines one or more parameters associated with a blood vessel under evaluation or in the selection of a particular medical device for use in treating a patient or group of patients. In certain embodiments, for example, the biomechanical model 31 uses input data obtained across several of the evaluation modules 32 to better understand the current condition of a patient's blood vessel, and from this information, selects a medical device (e.g., a patch or graft/stent) that is optimal for the patient. Example methods for evaluating potential treatment options for a patient using a fluid-solid interaction biomechanical model is further described with respect to FIGS. 12 and 13.

In some embodiments, the biomechanical model 31 uses coupled solid and fluid mechanics equations as well as data stored within the database 12 in a numerical algorithm that employs finite difference, peridynamic, other meshless, and/or finite element analysis in calculating stresses in blood vessel walls and blood flow parameters within an existing or reconstructed blood vessel. The biomechanical model 31 can also be used to calculate various mechanical and hemodynamic parameters linked to restenosis, such as maximum stress or cyclic stress or strain, wall pressure, wall shear stress, oscillatory shear stress, blood viscosity, and spatial gradients such as wall pressure gradients and wall shear stress gradients. Example model inputs that can be used by the biomechanical model 31 to calculate these stresses comprise the material properties of the blood vessel (e.g., linear, non-linear, isotropy, anisotropy, viscoelasticity), the deformation characteristics of the blood vessel (e.g., small versus large deformations), the blood flow characteristics of the blood vessel (e.g., laminar versus turbulent blood flows, Newtonian vs. non-Newtonian rheology), and the type of attachment and closure (e.g., closure with suture, stitching, frictional attachment).

The biomechanical model 31 can be used for predicting outputs associated with humans, animals, or both. In some embodiments, for example, the biomechanical model 31 employs an animal model for evaluating and predicting various outputs related to vascular interventions and reconstructions in animals such as rats, dogs, or pigs. Information acquired from the animal model may provide users 20, 30 with information for researching both the underlying mechanisms of diseases such as atherosclerosis as well as assisting in the development of improved materials, devices, and treatment methods. The biomechanical model 31 can employ semi-destructive, destructive, or non-invasive techniques for evaluating animals, either in vivo or postmortem. Simulated results from the biomechanical model 31 can be compared to data obtained and stored in the database 12. As with human data contained within the database 12, the animal data can be categorized and stored for later analysis by animal type, age, condition, as well as other categories.

The suite of evaluation modules 32 can be accessed by the system users 20, 30 to input and evaluate various physiologic parameters relating to current or past patients 22, 24 as well as device-specific parameters relating to those medical devices (e.g., patches, stents, grafts) that are available for treating the patients 22, 24. In the embodiment of FIG. 1, the suite of evaluation modules 32 includes a mechanical properties evaluation module 34 for inputting and evaluating data relating to the mechanical behavior of biological materials and medical devices such as patches, synthetic grafts, and stents; a blood rheology evaluation module 36 for inputting and evaluating data relating to the rheological behavior of blood, a blood vessel geometry evaluation module 38 for inputting and evaluation data relating to the geometry of a diseased or reconstructed blood vessel; a medical device geometry evaluation module 40 for inputting and evaluating data relating to medical device geometry; a boundary blood flow evaluation module 42 for inputting and evaluating data relating to blood flow properties, and a load evaluation module 44 for inputting and evaluating data relating to loads on the blood vessels. In some embodiments, each individual module 34, 36, 38, 40, 42, 44 includes an associated module database 46, 48, 50, 52, 54, 56 for storing module-specific data for later analysis and use. In certain embodiments, the module databases 46, 48, 50, 52, 54, 56 are a part of the database 12. In other embodiments, the module databases 46, 48, 50, 52, 54, 56 are separate databases that interact with the database 12.

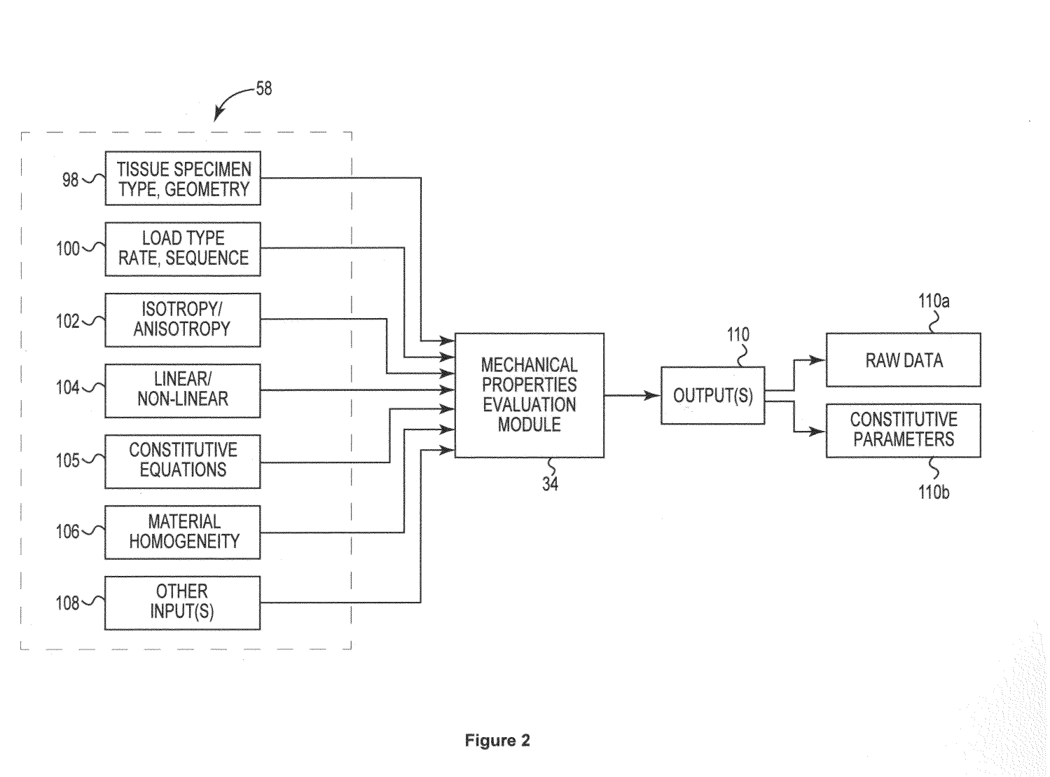

The mechanical properties evaluation module 34 is configured for use in inputting and evaluating various input parameters 58 relating to the mechanical behavior of biological materials and specimens such as blood vessels and plaque as well as the behavior of natural and synthetic grafts and stents used for treating such vessels. The data inputted to the mechanical properties input module 34 can be classified within the database 46 into appropriate groups, depending on the particular blood vessel under evaluation, the particular treatment method performed (e.g., endarterectomy with a natural graft), as well as other classifications. Example data that can be classified within the database 46 comprise the type of artery, patient age, disease type, disease stage, plaque extent, plaque composition, and natural graft source. Several example input parameters 58 that can be input to the database 46 for use in analyzing blood vessels, plaques, and natural grafts are further described with respect to FIG. 2.

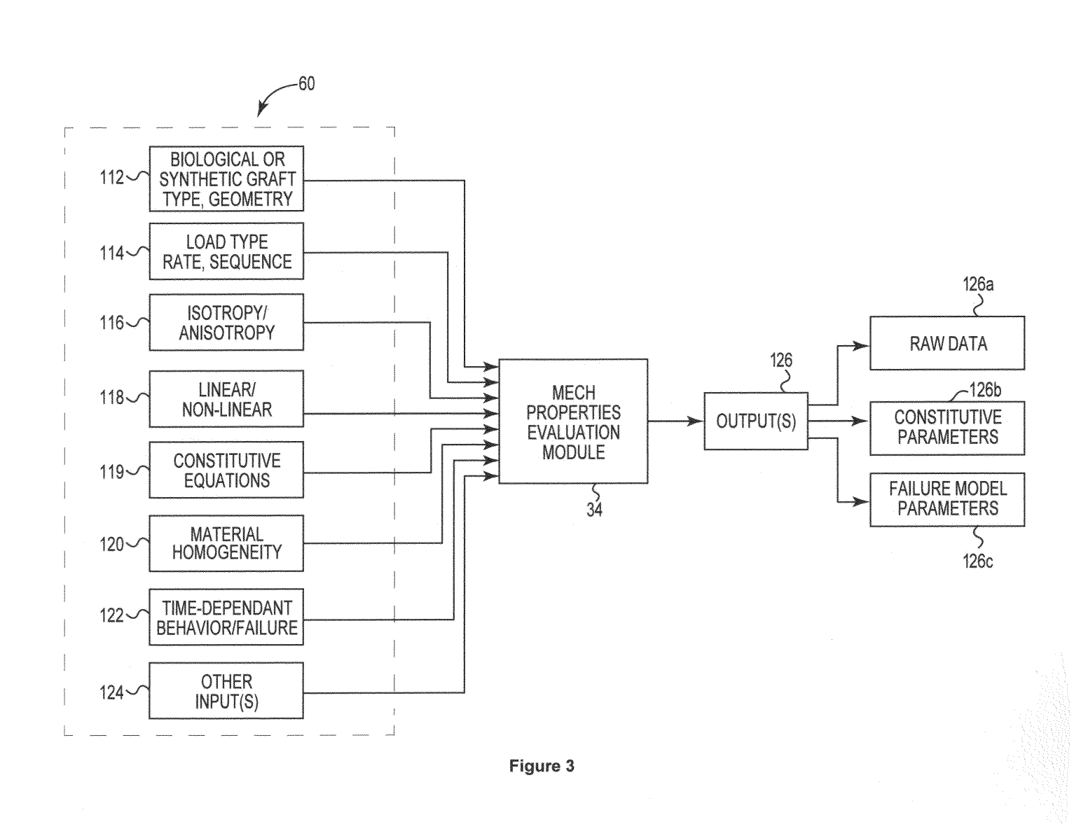

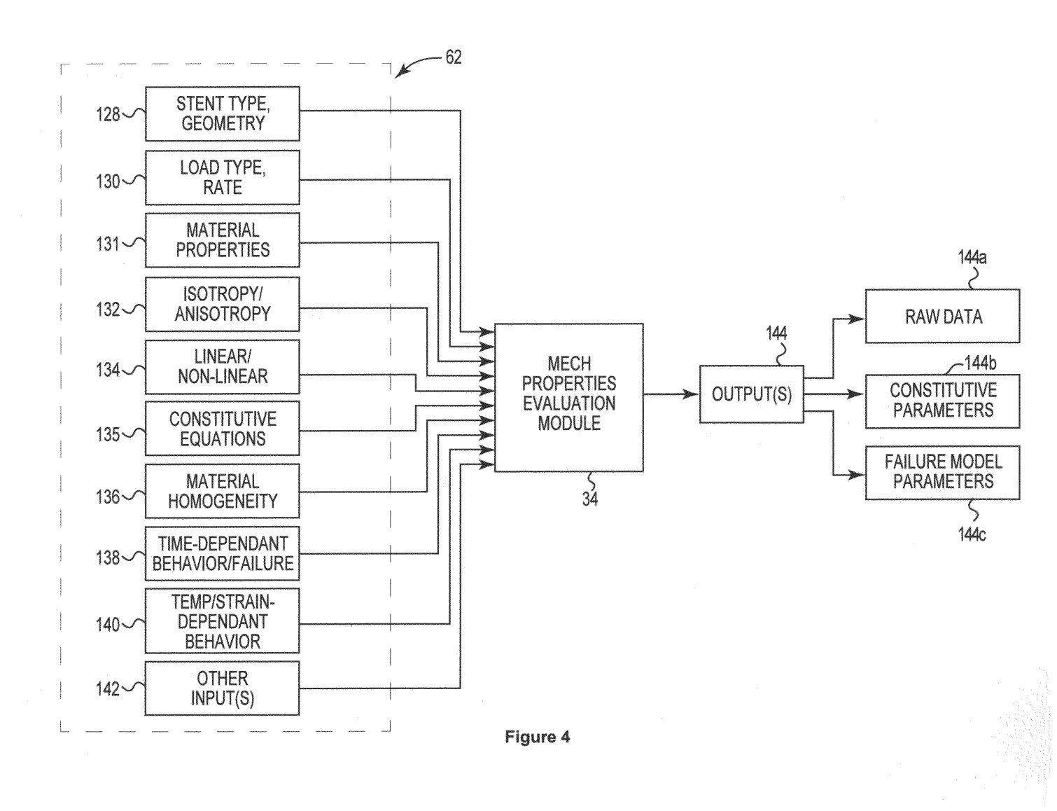

For the analysis of the mechanical behavior of synthetic grafts and stents, the data can be similarly classified into appropriate groups within the database 46 for later analysis by the mechanical properties evaluation module 34. Example data that can be classified within the database 46 comprise the type of material and coating, if any, the device manufacturer, U.S. Federal and Drug Administration (FDA) approval status, the frequency of use, and the percentage of known complications. Several example input parameters 60 that can be input to the database 46 for use by the mechanical properties evaluation module 34 in analyzing synthetic grafts are further described with respect to FIG. 3. Several example input parameters 62 that can be input to the database 46 for use by module 34 in analyzing stents are further described with respect to FIG. 4.

Different types of synthetic and natural grafts, stents, and other implantable devices can be evaluated using the mechanical properties evaluation module 34, including those commonly used for vascular repair, bypass, replacement, and post endarterectomy patching. Example graft types that can be evaluated comprise polytetrafluoroethylene (PTFE) and other biocompatible polymer grafts, textile Dacron grafts, biodegradable polymer grafts, vascular grafts, femoral vein/artery, aortoiliac artery, saphenous, external jugular and facial vein vascular grafts and allografts, bovine pericardium patches, tubular vascular conduits and prostheses, and v-shaped grafts. Example stent types that can be evaluated comprise shape memory alloys and steel stents, open cell and closed cell stents, self expanding stents, shape memory alloy stents, braided mesh stents, biodegradable stents, coated stents, and drug eluting stents.

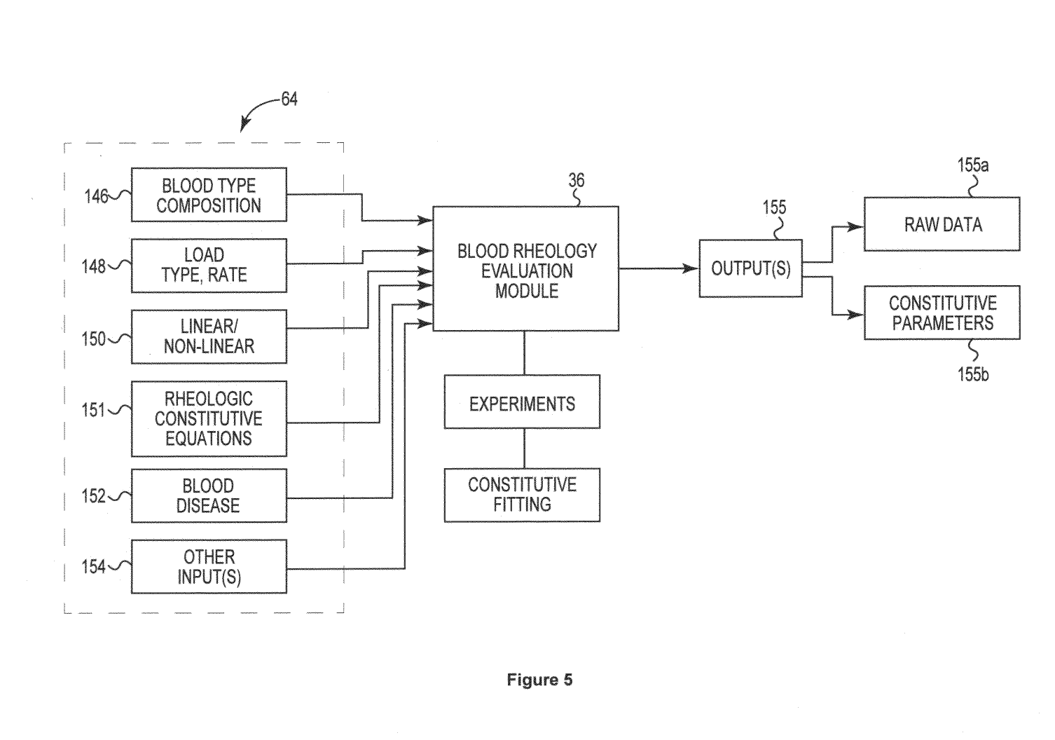

The blood rheology evaluation module 36 is configured for use in inputting and evaluating various parameters 64 relating to the rheological behavior of blood. The data inputted to the blood rheology evaluation module 36 can be classified within database 48 into appropriate groups for later analysis by the module 36. Example data that can be classified within the database 48 comprise blood composition parameters such as erythrocytes count and LDL/HDL cholesterol content, patient condition, and blood disease. Several input parameters 64 that can be input to the database 48 for use in analyzing rheological behavior of blood are further described with respect to FIG. 5.

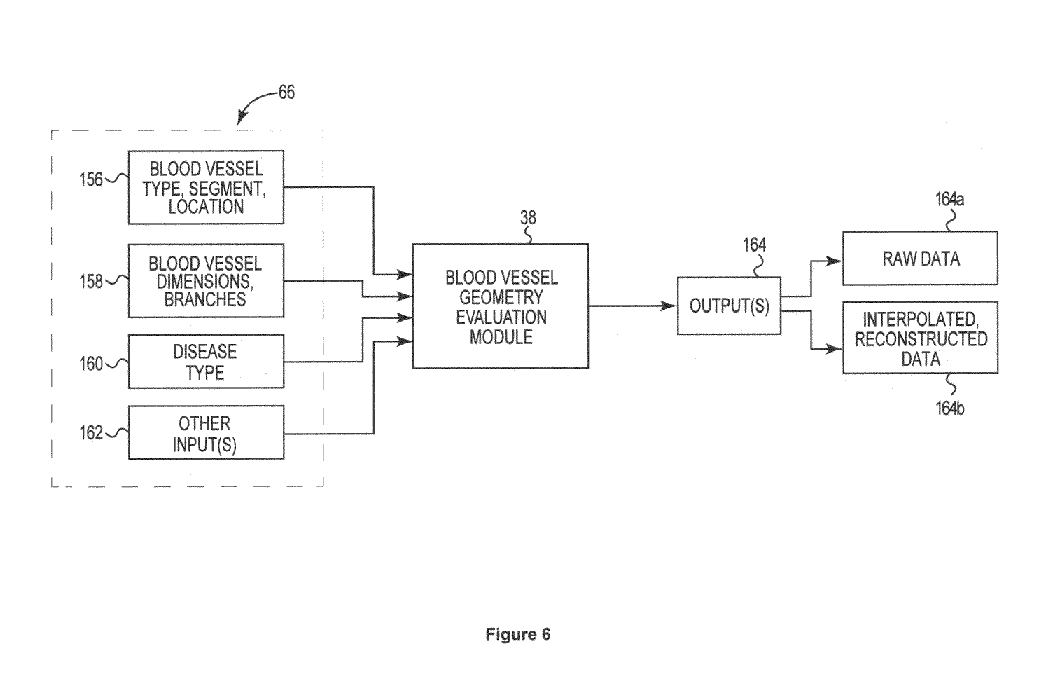

The blood vessel geometry input module 38 is configured for use in inputting and evaluating various input parameters 66 related to the geometry of a blood vessel being treated, or for bypass-type procedures involving diseased blood vessels, for evaluating input parameters 66 related to reconstructed vessels. The data inputted to the blood vessel geometry evaluation module 38 can be classified within the database 50 for later analysis by the biomechanical model 31. Example data that can be classified within the database 50 comprise vessel type, patient condition, disease type, and disease stage. Several example input parameters 66 that can be input to the database 50 for use in analyzing blood vessel geometry are further described with respect to FIG. 6.

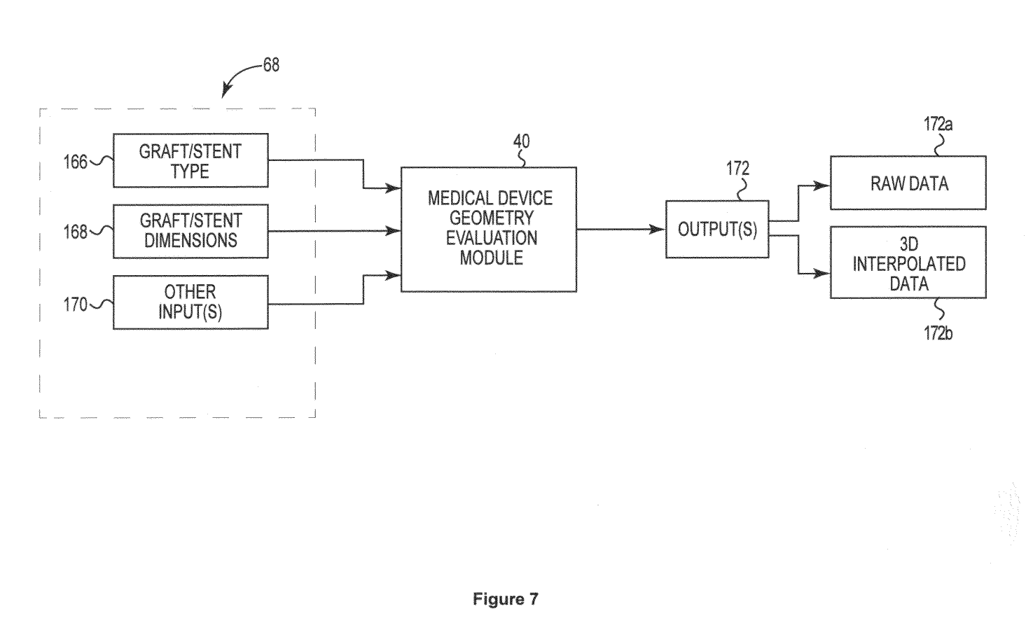

The medical device geometry input module 40 is configured for use in inputting and evaluating various input parameters 68 related to the geometrical properties (e.g., size, shape, curvature, etc.) of a graft or stent. The data inputted to the module 40 can be classified within the database 52 into appropriate groups for later analysis by the biomechanical model 31. Example data that can be classified within the database 52 comprise device type, manufacturer type, FDA approval status, frequency of use, and type and percentage of known complications. Several input parameters 68 that can be input to the database 52 for use in analyzing graft/stent geometry are further described with respect to FIG. 7.

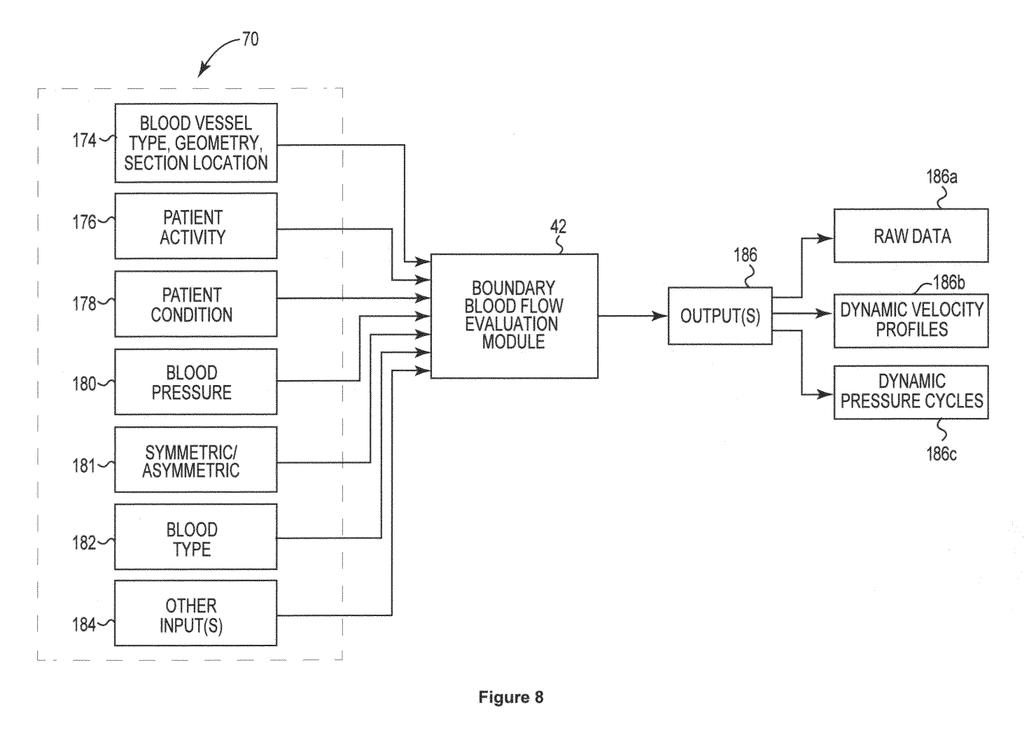

The boundary blood flow evaluation module 42 is configured for use in inputting and evaluating various input parameters 70 related to the flow of blood and blood pressure at the boundaries of a region under evaluation, such as, for example, at the boundaries of a diseased portion of a blood vessel to be treated or a reconstructed vessel. The data inputted to the boundary blood flow evaluation module 42 can be classified within the database 54 for later analysis by the module 42. Example data that can be classified within the database 54 comprise vessel type, arterial geometry characteristics, flow profile, pressure waveform, patient condition, patient activity, blood type, and reconstruction type. Several example input parameters 70 that can be input to the database 54 for use in analyzing blood flow parameters are further described with respect to FIG. 8.

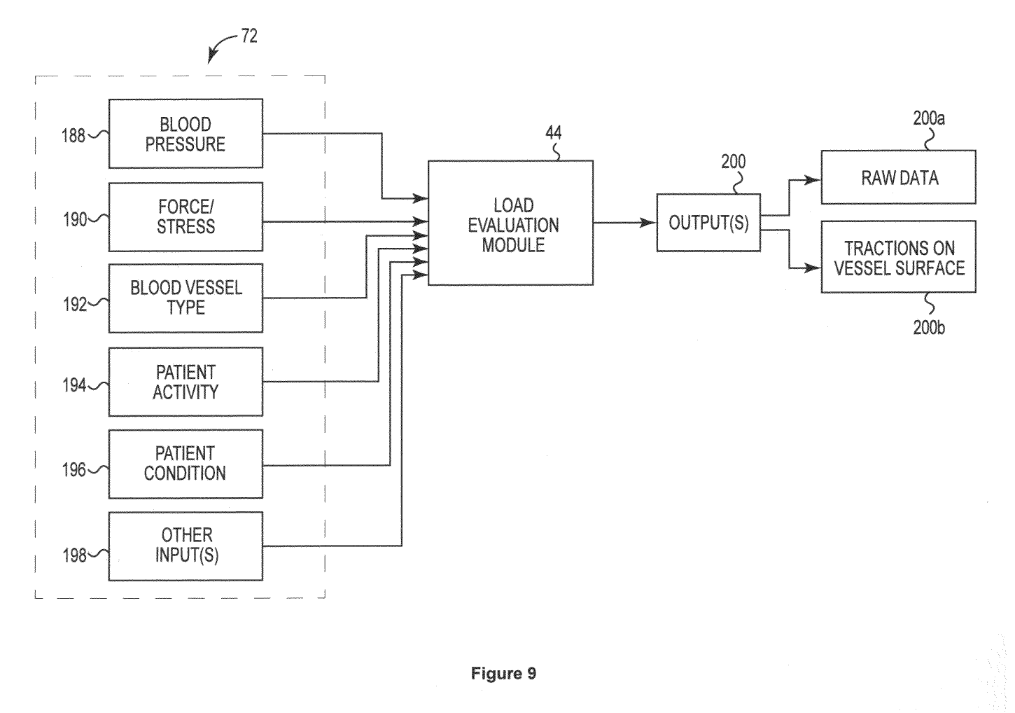

The load evaluation module 44 is configured for use in inputting and evaluating various input parameters 72 related to dynamic and static loads exerted on a blood vessel or other anatomical structure resulting from blood pressure, body movements, adjacent tissue, forces from expanded stents/grafts, extension/contractions due to movement and residual stresses, as well as other factors. The data inputted to the load evaluation module 44 can be classified within the database 56 for later analysis by the load evaluation module 44. Example data that can be classified within the database 56 comprise vessel type, arterial geometry characteristics, flow profile, patient condition, patient activity, and device or reconstruction type. Several example input parameters 72 that can be input to the database 56 for use in analyzing dynamic and static loads are further described with respect to FIG. 9.

The evaluation unit 14 is configured to directly compute biomechanics data outputs 73 for analysis by the users 20, 30. Examples of biomechanics data outputs 73 comprise time-dependent, three-dimensional distributions of stresses within a vessel wall, time-dependent; three-dimensional distributions of blood velocities, pressure, and shear stresses in blood; medical device material; and medical device geometry. The evaluation unit 14 can also be used to compute one or more derivative parameter outputs 74 associated with the biomechanics data. Example derivative parameter outputs 74 comprise atherosclerosis-related parameters including cyclic stress, cyclic strain, wall shear stress and their maxima/minima, areas/volumes over threshold(s), prediction of potential restenosis locations/volumes, and prediction of mechanical failures. The derivative parameter outputs 74 can comprise quantitative values, qualitative data, or a combination of both. In some embodiments, the derivative parameter outputs 74 are computed using additional modules such as a restenosis prediction module 76 or a failure prediction module 84, which contain additional models and model inputs.

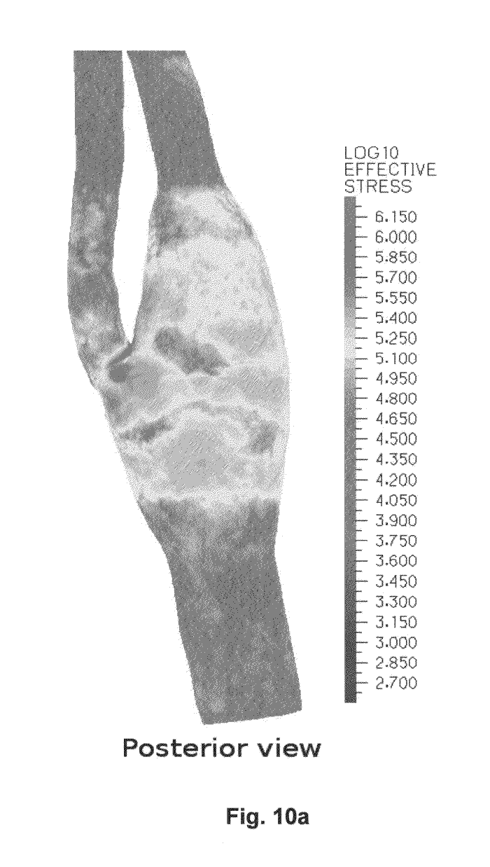

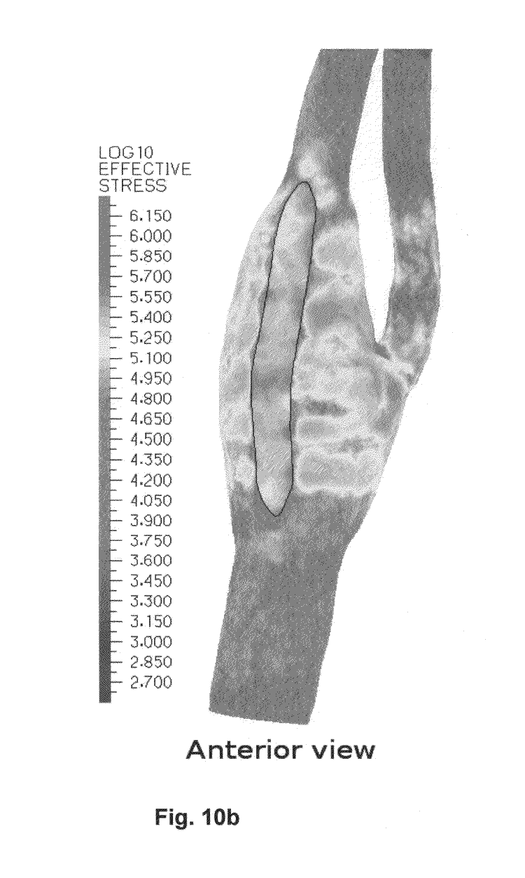

The restenosis prediction module 76 can be used for predicting the likelihood that restenosis will occur within a particular blood vessel. In certain embodiments, for example, the restenosis prediction module 76 includes functionality that links computed parameters such as vessel wall stresses and blood flow parameters to tissue remodeling and restenosis using an appropriate atherogenesis theory, which describes growth of atheromas or plaques in the inner lining of arteries. Alternatively, or in addition, the restenosis prediction module 76 includes functionality that links parameters such as vessel wall stresses and strains and blood flow characteristics to tissue using a hemorheologic-hemodynamic theory of atherosclerosis. An example of such prediction for a carotid artery is shown in FIGS. 10a-10b, which shows posterior and anterior three-dimensional visualizations of carotid artery stresses.

In some embodiments, the restenosis prediction module 76 comprises a model that links computed mechanical and hemodynamic parameters to atherogenesis. Various physiological and biochemical phenomena accompanying restenosis can also be incorporated into the restenosis prediction module 76. For example, the restenosis prediction module 76 can model mechanotransduction and the effects of mechanical stimuli on migration of endothelial cells (e.g. via the wound-healing model), the effects of stresses and high uniaxial/biaxial strains on SMC signaling, alignment, or apoptosis, various biochemical processes triggered by stress and strain induced gene expressions, as well as other physiological and biochemical phenomena. The restenosis prediction module 76 can also be used to evaluate the effects of restenosis-suppressing drugs eluted from drug-eluting stents or grafts. In addition, the restenosis prediction module 76 can also be used to evaluate various patient-specific factors known to affect atherogenesis such as, for example, morphological, genetic, metabolic, and hormonal factors as well as relevant diseases such as hypertension. In some embodiments, the restenosis prediction module 76 is configured to perform blood vessel remodeling to predict the development of stenotic-induced aneurysms resulting from a stenosis.

In certain embodiments, the restenosis prediction module 76 is configured to generate three-dimensional images of predicted restenosis localization and growth that can be compared with actual atherosclerosis localization using direct postmortem observations or a suitable imaging technique such as high-resolution CT, MRI, or ultrasound imaging. An example imaging technique for visualizing atherosclerosis localization includes hybrid PET-CT or PET-MRI imaging with appropriate biochemical atherogenesis markers. In some embodiments, and as further discussed herein, the restenosis prediction module 76 can be used in conjunction with an optimization evaluation module 78 to define various restenosis-related criteria and goals.

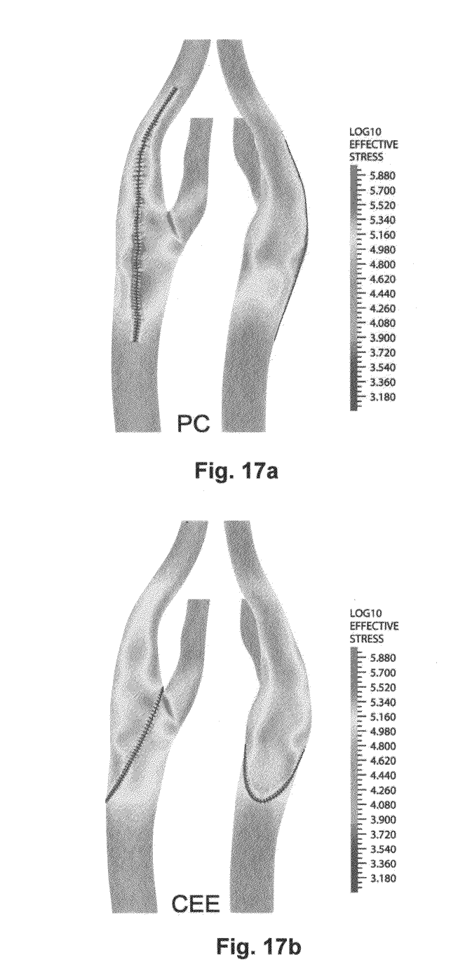

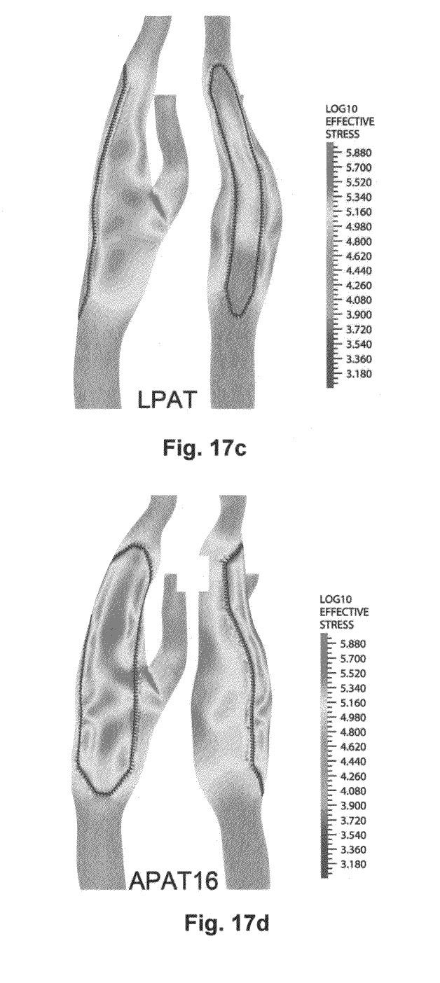

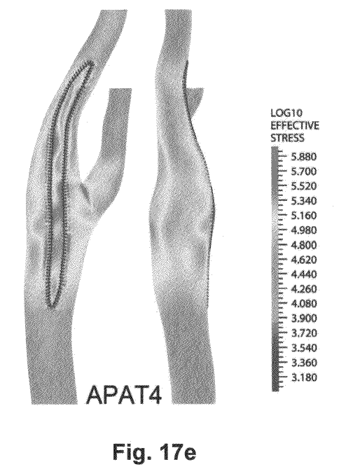

The treatment selection/optimization evaluation module 78 is configured for use in evaluating a range of available treatment options and for selecting a treatment that is best suited for a particular patient. Example treatment parameters that can be optimized via the module 78 comprise the type of treatment, the type of stent/graft material, the base geometry of the stent/graft, placement location, and attachment location/configuration. In use, the treatment selection/optimization evaluation module 78 employs a mathematical optimization routine using linear or non-linear programming techniques to automatically determine an optimized treatment plan based on the available data stored in the database 12. In some embodiments, the treatment selection/optimization evaluation module 78 continuously varies one or more discretionary variables based on user input preferences. For example, one or more surgeon-defined variables can be used as inputs by the treatment selection/optimization evaluation module 78 to determine an optimized treatment option that takes into account the surgeon's experience and preferences. Example discretionary variables that can be inputted comprise patch or stent size, type and shape preferences, placement location, and attachment location. An example of such an evaluation for a carotid artery repaired with different surgical reconstruction techniques is shown in FIGS. 17a-17e, in which “PC” represents a primary closure, “CEE” represents eversion endarterectomy, “LPAT” represents lateral patching, “APAT8” represents anterior patching with a standard 8 mm patch, “APAT16” represents anterior patching with a wide 16 mm patch, and “APAT4” represents anterior patching with a narrow 4 mm patch.

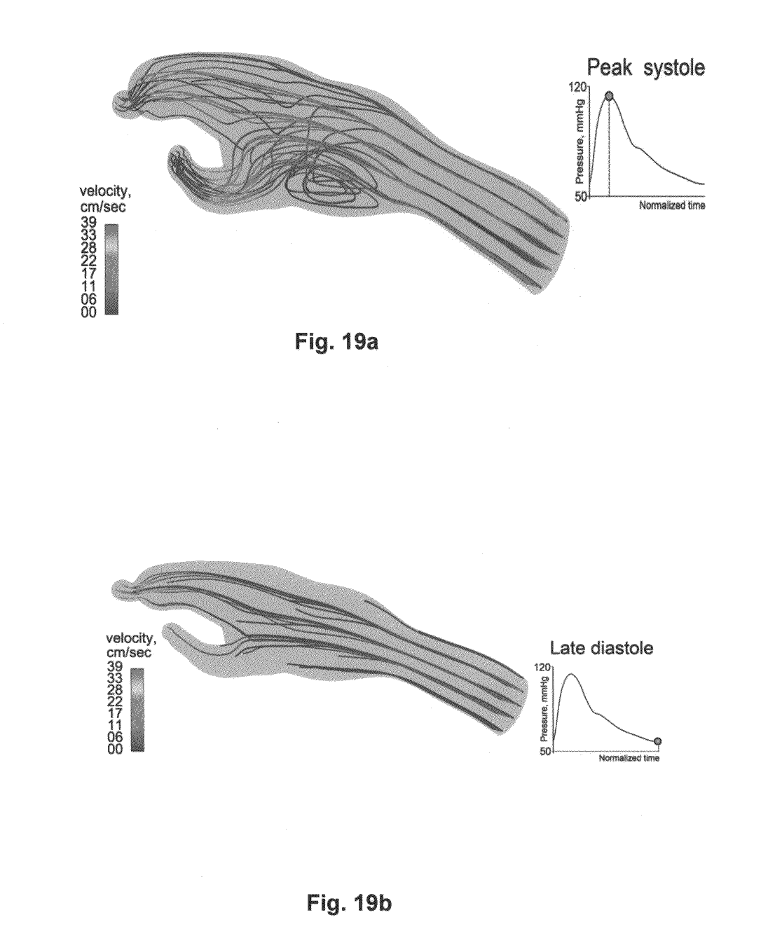

In some embodiments, the optimization of a particular treatment option can be performed by the treatment selection/optimization evaluation module 78 by visually evaluating the output from a graphical user interface (GUI) 90. Furthermore, and in some embodiments, the treatment selection/optimization evaluation module 78 can also be used to quantitatively compare outputs from several possible treatment options based on appropriate selection criteria. The selection criteria can be based, for example, on absolute maximum or cycle stress or strain intensities in the vessel walls, relative (e.g., percentage) increases in such intensities, comparisons of the vessel before repair to a healthy vessel, blood flow velocity (e.g., stagnation points), and wall shear stress. Other inputs from one or more of the evaluation modules 32 can also be used as selection criteria for optimizing a particular treatment. An example visualization showing flow abnormalities in a carotid bulb during systole and diastole is shown in FIGS. 19a and 19b, respectively.

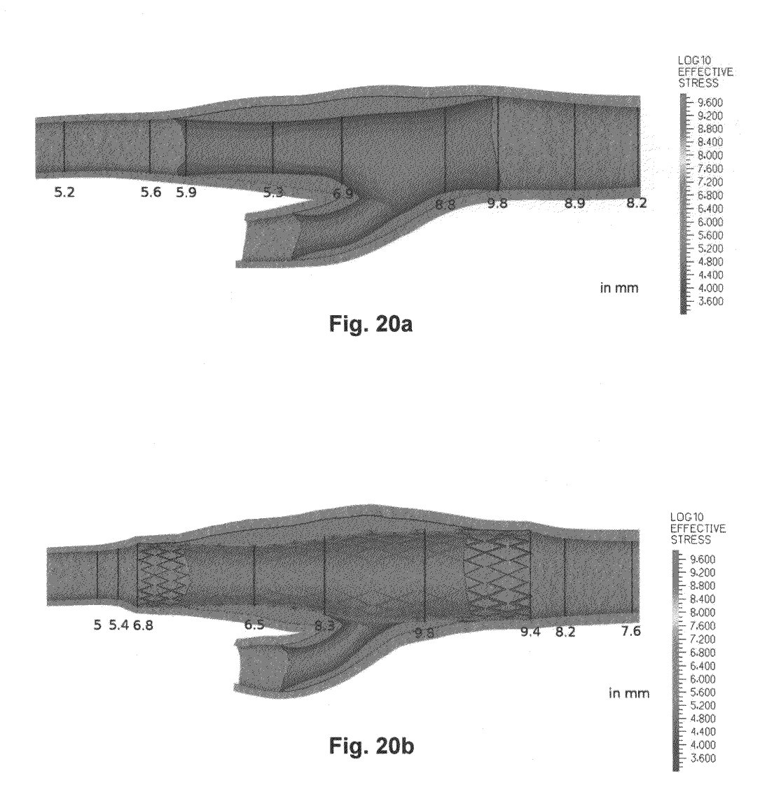

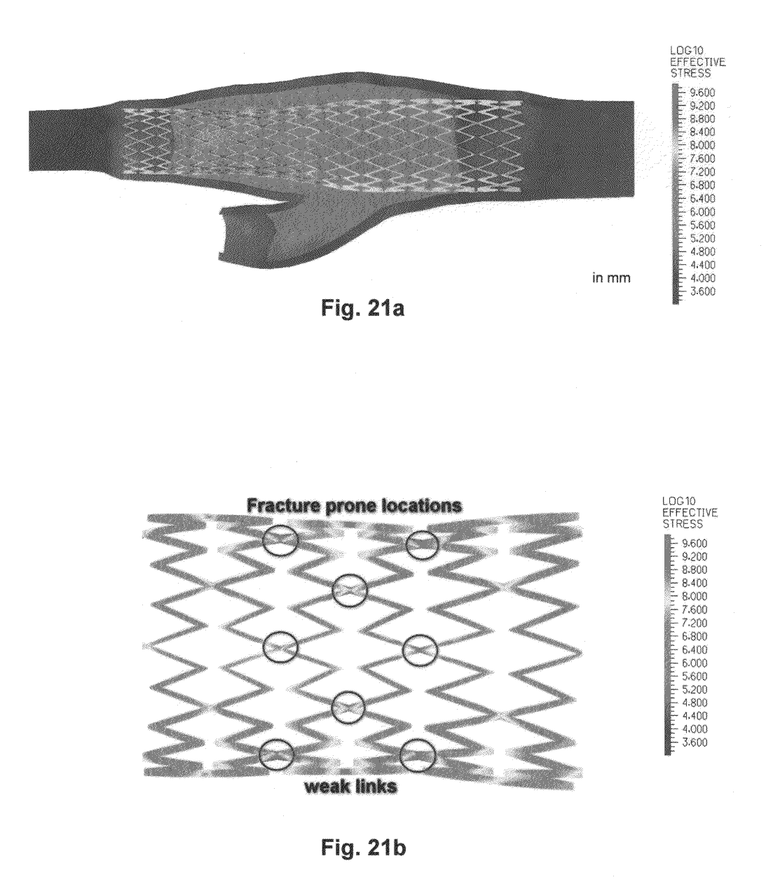

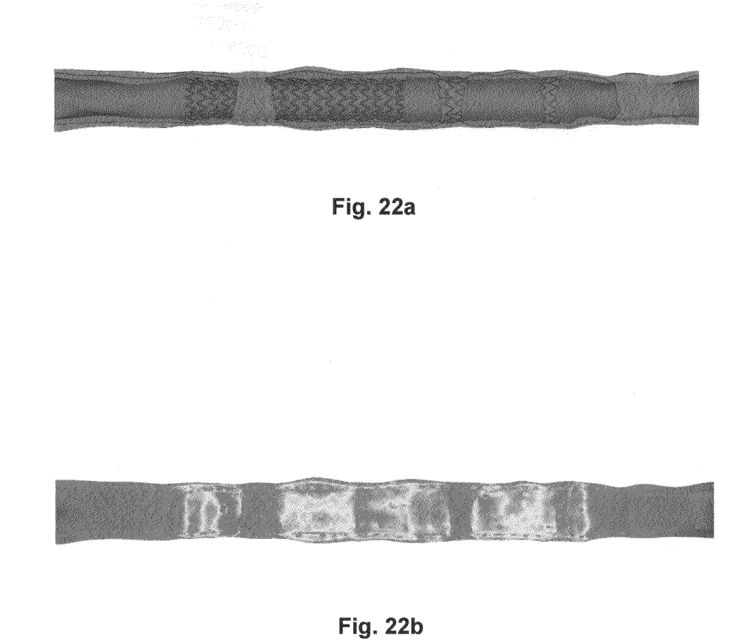

In some embodiments, the treatment selection optimization evaluation module 78 is configured to screen and rank specific user-selected treatment options for evaluation. Example options that can be screened and ranked comprise the type of treatment (e.g., angioplasty with or without stenting, endarterectomy followed by primary closure, eversion endarterectomy, endarterectomy followed by primary closure, and eversion endarterectomy with lateral or anterior patch closure), graft material (e.g., synthetic, biological, by comparison/ranking of FDA-approved patches), the graft or stent geometry (e.g., shape, size, diameter, length, open cell, closed cell), the graft or stent placement (e.g., implantation position, overlaps), and attachment/bonding to the vessel (e.g., stitching, self-expanded, balloon-expanded). Examples of such treatment screening for carotid and superficial arteries is shown in FIGS. 20-22.

A design evaluation module 80 is configured for use in evaluating material properties, device geometries, and other design parameters for new materials or device designs. The design evaluation module 80 can be used, for example, by medical device developers or material developers in developing new materials or device geometries for improving, and in some case optimizing, treatment outcomes. In the context of endarterectomy procedures, for example, the design evaluation module 80 can be utilized as a guide for medical device developers to develop new materials and geometries for implantable devices such as grafts and stents. Various user-specified ranges of allowable material properties and device parameter combinations can be examined by the design evaluation module 80, either manually, semi-automatically, or automatically. The design evaluation module 80 can utilize mean anatomic, physiological, and other patient-related data computing using the database entries for multiple patients such as, for example, patients belonging to a specific group. When computed for specific groups, the module outcomes will be related to that group. In other embodiments, the design evaluation module 80 can be used in conjunction with individual patient inputs, thus designing the materials and/or devices for that specific patient.

In some embodiments, the design evaluation module 80 uses pre-characterized design moduli stored within the database 12 for developing new materials and/or devices. In certain embodiments, the design moduli comprise optimization parameters contained within the database 12 that can be applied to a model used by the design evaluation module 80 to achieve a particular goal. For example, in developing new materials for synthetic grafts, the design evaluation module 80 can employ various micromechanics models of heterogeneous porous or composite synthetic graft materials to select an appropriate composition and structure to achieve a desired property such as anisotropy ratio, certain types of non-linearity, strength, fatigue resistance, or biocompatibility. In similar fashion, stent geometry and composition can be adjusted to achieve certain goals. In some embodiments, the design evaluation module 80 also uses individual patient measurements for individualizing the design and manufacturing of materials and/or structures to the patient's particular needs.

In some embodiments, the output results from the design evaluation module 80 can be fed to a programmable manufacturing device 82 capable of automatically producing the new material or device based on the optimized material or structure. Example manufacturing devices 82 capable of automatically producing new materials or devices comprise automatic programmable devices for producing porous materials, automated programmable lay-up devices for producing composite materials, and automated laser cutting devices for programmable stent manufacturing.

A failure prediction module 84 is configured for use in evaluating potential failures associated with graft materials, stents, or other implantable devices. In addition to restenosis, implantable devices such as grafts and stents can also fail mechanically under long-term cyclic loading, typically through the gradual accumulation and propagation of cracks or other irregularities in the structure. In some cases, the mechanical failure of the device can lead to immediate artery blockage or thrombosis. Such mechanical failures can also lead to high wall stresses, abnormal flow shear stress and disturbed blood flow patterns at the location of the failure, which can result in a rapidly accelerated restenosis or other complications. The failure of implantable devices such as grafts and stents thus represents a specific modality of possible post vascular surgery complications which, in addition to restenosis, can affect long-term treatment outcomes. Examples of zones prone to potential failure of a repair device used to repair carotid and superficial arteries are shown in FIGS. 19-20.

In some embodiments, the failure prediction module 84 applies measured input parameters to a failure prediction model that uses a combination of static and fatigue strength, damage, and fracture mechanics approaches typically employed for analyzing structural materials. Based on the measured input parameters, the failure prediction module 84 is configured to predict and track gradual failure progression in grafts and stents. The failure prediction module 84 also considers the effects of changes in the material properties of the graft or stent during fatigue degradation along with the associated changes in wall stresses and blood flow patterns along with the effects of restenosis. In some embodiments, the evaluated and predicted cyclic graft or stent durability can be used as a goal or criteria for designing improved grafts or stents that are less likely to fail or cause restenosis.

Other modules can also be utilized for evaluating other physiological parameters associated with a patient 22, 24 or group of patients 22, 24, for evaluating material or structural parameters for devices to be used for treating patients 22, 24, or for performing other tasks. In addition, data acquired from one or more of the modules 32 can be analyzed by one or more other modules to evaluate, and in some cases predict, other parameters. Although each of the modules 32 are described functionally as separate modules, in other embodiments one or more of the modules can be combined together into a single module or groups of modules. Furthermore, one or more of the modules 32 can comprise an external module that is physically embodied on another computing device or multiple devices.

In those embodiments in which the system is accessible to multiple users 20, 30 (e.g., as a software program operable over a network server or as a stand-alone software program), the number and type of modules made available to the users 20, 30 may vary depending on the user type. Thus, while several example modules 32 are shown in FIG. 1, the particular configuration of the system 10, including the types and functionality of modules 32 available to a particular user 20, 30, may vary depending on the particular application. For health care professions, for example, the functionality provided by the modules 32 include features that assist in inputting potential treatment options for patients whereas the functionality provided by the modules 32 for researchers are focused on research-related functionality.

The system users 20, 30 can interact with the database 12 and other system components either directly or via the network interface 26. In some embodiments, an interactive graphical user interface (GUI) 90 can be used by the users 20, 30 for analyzing data generated by the biomechanical model 31 and/or the various modules 32. In certain embodiments, for example, the graphical user interface 90 can be used by surgeons and health care professionals for preoperative analysis, evaluation, and visualization of treatment outcomes for individual patients or groups of patients, or for optimizing potential treatment options. For example, the graphical user interface 90 can be used by surgeons in endarterectomy procedures for manipulating surgical outputs such as graft/stent size and placement location based on various physiological parameters assessed visually using MRA, CTA, or other suitable visualization technique, and based on patient ECG data.

The graphical user interface 90 includes database tools 91 for use in performing various database operations, model assembly tools 92 for use in generating models, simulation control tools 93 for use in performing biomechanics modeling and simulation operations, output analysis and visualization tools 94 for performing analyses on outputs generated by the evaluation unit 14, and optimization control tools 95 for use in optimizing outputs generated by the evaluation unit 14.

Example database operations that can be performed via the database tools 91 comprise importing data into the database 12 as well as formatting, reducing, labeling, storing, and/or performing other operations associated with such data. The database tools 91 can also include a search query module that can be used for searching the database 12. In certain embodiments, for example, the search query module comprises a search bar or interactive interface displayed on the graphical user interface 90, allowing the users 20, 30 to search for data in the database 12 by inputting a text query or by answering a series of questions.

Example biomechanics operations that can be performed via the model assembly tools 92 comprise inputting patient data directly to the biomechanical model 31, selecting additional data from the database 12 (e.g., via searching, comparing, selecting functions), assembling three-dimensional blood vessel models, and running biometric simulations.

Example visualizations that can be provided via the simulation control tools 93 comprise three-dimensional graphs with areas or volumes that are color or gray-level coded to indicate stress, strain, and velocity intensities, vector plots for indicating intensity and direction, three-dimensional geometry of regrown tissue due to remodeling, animation videos showing deformation and stress/velocity changes over time during cyclic or other dynamic loading or as a result of biodegradation or other long-term phenomena in vessels or grafts/stents, sectioning for still-graphs, and animated videos for representing complex three-dimensional distributions of parameters. The sectioning of items on the graphical user interface 90 can be pre-determined or made adjustable based on user input. An example three dimensional visualization of the stresses within a blood vessel is shown in FIG. 10.

Example analyses and/or optimization operations that can be performed via the output analysis and visualization tools 94 and the optimization control tools 95 comprise computing derivative output parameters on biomechanics data outputs, visualizing anatomical structures for evaluation or comparison (e.g., via mapping color-coded parameters over pulsating blood vessel surface and/or section of a vessel), for performing side-by-side visual comparisons of multiple treatment options under consideration, for computing maxima/minima and/or areas/volumes over a threshold for quantitative comparison of multiple treatment options, for performing automatic or semi-automatic optimizations (e.g., using computational loops and/or non-linear programming methods), and for storing or exporting optimal treatment techniques, materials, devices, and adjustable parameters for further use by surgeons, materials developers, or medical device manufacturers.

In some embodiments, the graphical user interface 90 can be utilized for performing postoperative evaluations to assess the quality and patency of a completed therapy, or to evaluate possible reasons for detected or diagnosed anomalies or other complications. For complications such as restenosis, for example, the graphical user interface 90 can be used to perform research on the underlying cause or causes of the restenosis, and in some cases, can be used to individualize patient care. In some embodiments, the graphical user interface 90 can be used for performing real-time evaluations of a selected treatment option during an interventional procedure based on either real-time, intraoperative measurements obtained from the patient or based on a combination of real-time and preoperative measurements stored within the database 12. The ability to analyze and predict outcomes based on such data may be of particular interest in the case of an emergency or when intraoperative complications may arise with little or no preparatory time.

The graphical user interface 90 can be used to quantitatively and/or qualitatively evaluate certain conditions based on appropriate selected criteria. The selection criteria can be based, for example, on absolute maximum or temporal mean or cyclic values of stress and/or strain intensities in the vessel walls, relative (e.g., percentage) increases in such intensities compared to the vessel before repair or to a healthy vessel, blood flow velocity characteristics (e.g., stagnation points), and wall shear stress. The processor 18 is configured to find critical spots, calculate their extent, and color-code them onto three-dimensional visualization outputs, such as graphs and videos, that can be displayed on the graphical user interface 90 for analysis. The users 20, can select between one or multiple, pre-programmed, interactively adjustable threshold levels, and perform other tasks via the graphical user interface 90. Three-dimensional geometric information obtained via an imaging system can be combined as a composite image on the graphical user interface 90 along with the localization of targeted biochemical events identified by markers. The resultant, calculated three-dimensional images containing marked critical locations can then be directly compared with restenosis occurring in treated patients 24 for further analysis.

FIG. 2 is a schematic view showing several example input parameters 58 for use by the mechanical properties evaluation module 34 of FIG. 1 in analyzing the behavior of biological materials and anatomical structures such as blood vessels, plaques, and natural grafts. As shown in FIG. 2, the mechanical properties evaluation module 34 receives, as input parameters 58, a specimen type/geometry input parameter 98, a load type, rate, and sequence input parameter 100, an isotropy/anisotropy input parameter 102, a linear/non-linear input parameter 104, a constitutive equations input parameter 105, and a material homogeneity input parameter 106. The specimen type input parameter 98 relates to the type of blood vessel to be evaluated. For example, if the specimen to be evaluated is a natural graft, the specimen type input parameter 98 can be used to select the type and source of the graft (e.g., natural graft: saphenous or external jugular vein) and its geometry. If the specimen to be evaluated is plaque, the specimen type input parameter 98 can be used to input data relating to the extent and composition of the plaque.

The load type input, rate and sequence parameter 100 relates to the loading conditions (e.g., uniaxial or biaxial, rate, sequence) in which blood vessel or graft measurements were acquired. The isotropy/anisotropy input parameter 102 relates to whether the blood vessel or graft is to be approximated by the biomechanical model 31 as either isotropic or anisotropic. The linear-/non-linear input parameter 104, relates to whether the blood vessel or graft is to be approximated by the biomechanical model 31 as either linear or non-linear (e.g., hyperelastic), elastic, or viscoelastic. The constitutive equations input parameter 105 relates to the equations to be used by the module 34 in evaluating outputs. The material homogeneity input parameter 106 relates to whether the blood vessel or graft is to be modeled as a homogenous or heterogeneous material. For a heterogeneous material, the mechanical behavior can be approximated by a composite mechanical model that uses the measured behavior of multiple components or constituents. For example, blood vessel walls can be considered as a layered, heterogeneous structure consisting of the intima, media, and adventitia, each with distinct, measurable properties. Plaque, in turn, can be considered as a heterogeneous structure consisting of dense, relatively acellular fibrous tissue, calcified tissue, pultaceous debris (i.e., amorphous debris containing cholesterol clefts rich in extracellular lipid), and cellular fibrous tissue.

The mechanical properties evaluation module 34 can be further configured to receive one or more other measured or modeled input parameters 108 for analysis. Examples of other parameters 108 that can be input to the mechanical properties evaluation module 34 comprise chemical, mechanical, or electrical characteristics of the structure to be evaluated, data input to other evaluation modules, as well as the outputs generated by other evaluation modules.

Based on the input parameters 58, experiments, constitutive fittings, and other factors are used by the mechanical properties evaluation module 34 to generate one or more outputs 110 associated with the condition of the blood vessel, plaque or graft. Examples of outputs 110 that can be evaluated comprise raw data 110a such as stress/strains and constitutive parameters 110b that describe blood, arterial wall, plaque and repair material or device behavior, tissue growth and remodeling conditions.

FIG. 3 is a schematic view showing several example input parameters 60 for use by the mechanical properties evaluation module 34 in analyzing the behavior of synthetic grafts. As shown in FIG. 3, the mechanical properties evaluation module 34 receives, as input parameters 60, a synthetic graft type and geometry input parameter 112, a load type, rate, and sequence input parameter 114, an isotropy/anisotropy input parameter 116, a linear/non-linear input parameter 118, a constitutive equations input parameter 119, a material homogeneity input parameter 120, and a time-dependent behavior/failure input parameter 122.

The graft mechanical properties can be either evaluated experimentally or by modeling. For synthetic grafts such as polytetrafluoroethylene (PTFE) grafts, the material can be modeled as a porous material whose behavior is approximated based on the behavior of PTFE and the volume fraction and shape of the pores. For textile grafts, the behavior can be predicted based on the fiber properties and textile structure. For biodegradable polymeric grafts, the mechanical properties evaluation module 34 is further configured to receive a time-dependent behavior/failure input parameter 122 that takes into account the degradation characteristics of the graft over time. One or more other measured or modeled input parameters 124 can also be received for analysis by the mechanical properties evaluation module 34.

Based on the input parameters 60, experiments, constitutive fittings, failure model fittings, and other factors are used by the mechanical properties evaluation module 34 to generate one or more outputs 126 associated with the synthetic graft. Examples of outputs 126 that can be evaluated comprise raw data 126a, constitutive parameters 126b (e.g., tissue remodeling laws that describe the tissue growth within and around the graft), and failure model parameters 126c (e.g., time-dependent change of graft material properties).

FIG. 4 is a schematic view showing several example input parameters 62 for use by the mechanical properties evaluation module 34 in analyzing the behavior of stents. As shown in FIG. 4, the module 34 receives, as input parameters 62, a stent type and geometry input parameter 128, a load type input parameter 130, a material properties input parameter 131, an isotropy/anisotropy input parameter 132, a linear/non-linear input parameter 134, a constitutive equations input parameter 135, and a material homogeneity input parameter 136. The stent type and geometry input parameter 128 can be used to select the type and geometry of the stent to be analyzed. For example, the stent type input and geometry parameter 128 can be used to select between evaluating a quasi-homogenous solid shell stent or a wire-mesh type stent. In the context of homogenous type stents, the load type and rate input parameter 130 relates to whether the stent is to be modeled as axially loaded under tension or compression (i.e., uniaxial loading), or simultaneous radial expansion, axial tension/compression and torsion (i.e., biaxial loading including the effects of shear).

For biodegradable polymeric stents, the module 34 is further configured to receive a time-dependent failure/behavior input parameter 138 that is used for evaluating the degradation characteristics of the stent over time. For stents made from shape-memory alloys, the temperature and strain-dependent behavior of the alloy can be provided as an input parameter 140 to the mechanical properties evaluation module 34, either as a measured value or approximated based on modeling. One or more other measured or modeled input parameters 142 can also be received for analysis by the mechanical behavior evaluation module 34.

Based on the input parameters 62, experiments, constitutive fittings, failure model fittings, and other factors are used by the mechanical behavior evaluation module 34 to generate one or more outputs 144 associated with the stent. Examples of outputs 144 that can be evaluated comprise raw data 144a, constitutive parameters 144b (e.g., tissue growth laws within the stent, degree of inflammation), and failure model parameters 144c (e.g., number and severity of developed cracks, stent migration, and alteration of stent and adjacent wall geometry).

FIG. 5 is a schematic view showing several example input parameters 64 for use by the blood rheology evaluation module 36 of FIG. 1 in analyzing rheological behavior of blood. As shown in FIG. 5, the blood rheology evaluation module 36 receives, as input parameters 64, a blood type and composition input parameter 146, a load type and rate input parameter 148, a linear/non-linear input parameter 150, a rheologic constitutive equation input parameter 151, and a blood disease input parameter 152. The blood type and composition input parameter 146 relates to the specific blood type and composition of the patient's blood, and includes factors such as erythrocytes count and LDL/HDL cholesterol content. The load type and rate input parameter 148 relates to the loading conditions of blood. The linear/non-linear input parameter 150 relates to whether the blood is to be approximated by the blood evaluation module 36 as either a Newtonian or non-Newtonian fluid for purposes of modeling. The rheoologic constitutive equation input parameter 151 relates to the rheologic equations to be used for modeling. The blood disease input parameter 152 relates to whether the patient has a particular blood-related disease or disorder, and if so, provides specific information related to that disease or disorder such as the disease stage. If, for example, the patient has Leukemia, the blood disease input parameter 152 can be used to input the type of Leukemia (i.e., lymphocytic or myelogenous) and the severity of the disorder (i.e., acute or chronic). One or more other measured or modeled input parameters 154 can also be received for analysis by the blood rheology evaluation module 36.

Based on the input parameters 64, experiments, constitutive fittings, and other factors are used by the blood evaluation module 36 to generate one or more outputs 155 associated with the patient's blood. Examples of outputs 155 that can be evaluated comprise raw data 155a such as blood viscosity, shape and size of erythrocytes and constitutive parameters 155b such as laws to describe the viscous properties of blood.

FIG. 6 is a schematic view showing several example input parameters 66 for use by the blood vessel geometry evaluation module 38 of FIG. 1 in analyzing the geometry of blood vessels or reconstructed blood vessels. As shown in FIG. 6, the blood vessel geometry evaluation module 38 receives, as input parameters 66, a blood vessel type, segment, and location input parameter 156, a blood vessel dimensions and branches input parameter 158, and a disease type input parameter 160. The blood vessel type, segment, and location input parameter 156 relates to the type and location of the blood vessel to be treated. For reconstructed blood vessels using harvested vessels, the blood vessel type, segment, and location input parameter 156 relates to the type and location of the harvested vessel. The blood vessel dimensions and branches input parameter 158 relates to the dimensions and branches of the vessel being treated, or for vessel reconstructions, the dimensions of the vessel to be reconstructed. The disease type input parameter 160 relates to whether the patient has a particular blood vessel disease or disorder, and if so, provides specific information related to that disease or disorder such as the disease stage. If, for example, the patient has atherosclerosis, the disease type input parameter 160 can be used to input the type and the severity of the disease to the module 38. One or more other measured or modeled input parameters 162 can also be received for analysis by the blood vessel geometry evaluation module 38.

Based on the input parameters 62, experiments, medical imaging, border identification, and other factors are used by the blood vessel geometry evaluation module 38 to generate one or more outputs 164 associated with vessel geometry. Examples of outputs 164 that can be evaluated comprise raw data 164a and interpolated/reconstructed data 164b (e.g., arterial tortuosity, curvatures, branching angles, variable wall thickness, length of segment under consideration, three-dimensional shape).

FIG. 7 is a schematic view showing several example input parameters 68 for use by the medical device geometry evaluation module 38 in analyzing the geometry of a medical device such as a graft or stent. As shown in FIG. 7, the medical device geometry evaluation module 40 receives, as input parameters 68, a graft/stent type input parameter 166 and a graft/stent dimensions input parameter 168. The graft/stent type input parameter 166 relates to the type and/or manufacturer of the device. The graft/stent dimensions input parameter 154 relates to the specific graft/stent length, the size or shape of a patch, or any other user-selectable geometric parameter. In some embodiments, the dimensions for various devices can be stored in the database 12, or can be varied by the clinician. One or more other measured or modeled input parameters 170 can also be received for analysis by the medical device geometry evaluation module 38.

Based on the input parameters 64, three-dimensional imaging data/reconstructions and other factors are used by the medical device geometry evaluation module 38 to generate one or more outputs 172 associated with the graft or stent geometry. Examples of outputs 172 that can be evaluated comprise raw data 172a and three-dimensional interpolated data 172b.

FIG. 8 is a schematic view showing several example input parameters 70 for use by the boundary blood flow evaluation module 42 of FIG. 1 in analyzing blood flow. As shown in FIG. 8, the boundary blood flow evaluation module 42 receives, as input parameters 70, a blood vessel type, geometry, and section location input parameter 174, a patient activity input parameter 176, a patient condition input parameter 178, a blood pressure input value 180, a symmetric/asymmetric input value 181, and a blood type input parameter 182. The blood vessel type, geometry, and section location input parameter 174 relates to the type and location of the blood vessel to be treated. The patient activity input parameter 176 relates to the general activity level of the patient, such as “active,” or “sedentary.” The patient condition input parameter 178 relates to the general condition of the patient. In some embodiments, for example, the patient condition input parameter 178 relates to the patient's specific condition. The symmetric/asymmetric input parameter 181 relates to the symmetry of blood flow conditions. The blood type input parameter 182 relates to the specific blood type of the patient. One or more other measured or modeled input parameters 184 can also be received for analysis by the boundary blood flow evaluation module 42.

Based on the input parameters 70, experiments, interpolations, and other factors are used by the boundary blood flow evaluation module 42 to generate one or more outputs 186 associated with blood flow. Examples of outputs 186 that can be evaluated comprises raw data 186a, dynamic velocity profiles 186b, (e.g., three-dimensional pulsatile blood velocity profiles at various locations of an arterial tree, peak velocity values and their corresponding luminal locations), and dynamic pressure cycles 186c.

FIG. 9 is a schematic view showing several example input parameters 72 for use by the load evaluation module 44 of FIG. 1 in analyzing dynamic and static loads exerted on blood vessels, reconstructions, or other anatomical structures. As shown in FIG. 9, the load evaluation module 44 receives, as input parameters 72, a blood pressure input parameter 188, a force/stress input parameter 190, a blood vessel type input parameter 192, a patient activity input parameter 194, and a patient condition input parameter 196. The blood pressure input parameter 188 comprises the patient's systolic and diastolic blood pressure during one heart cycle or across multiple heart cycles (e.g., an averaged blood pressure). The force/stress input parameter 190 relates to external forces applied to the vessel, including, but not limited to, forces from surrounding tissue, neighboring grafts and stents, extensions and contractions due to locomotion, and residual stresses. The forces can be measured and/or evaluated at particular times such as during a period of maximum load, at systole/diastole, or during peaks in cardiac activity. The forces can also be measured continuously through dynamic or cyclic activities. One or more other measured or modeled input parameters 198 can also be received for analysis by the load evaluation module 44.

Based on the input parameters 72, measurements, back calculation of tractions, and other factors are used by the load evaluation module 44 to generate one or more outputs 200 associated with loading. Examples of outputs 200 that can be evaluated comprise raw data 200a and tractions on the vessel surface 200b (e.g., maps of distributed loads on arterial walls and repair devices, boundary conditions, interactions with surrounding tissues).

The various input parameters supplied to the evaluation modules 32 can be measured in-vitro, in-vivo, or a combination of both. For example, geometry and in vivo mechanical properties of the patient's blood vessels and/or atherosclerotic plaque can be measured using invasive or non-invasive ultrasound, MRA, PET-CTA, or CTA while mechanical properties of the repair materials and devices can be determined using in vitro biaxial tests.

FIG. 11 is a schematic view showing an example software platform 202 for use with the system 10 of FIG. 1. The software platform 184 may represent, for example, a service-orientated software architecture comprising a suite of software tools that can be used in a cloud-based environment with multiple, Web-based users 20. The software platform 202 comprises a three distinct, distributed layers 204, 206, 208 that provide software functionality for communicating with the system components and with each user 20. A data layer 204 provides access to the underlying data manipulation functionality and data repositories. In some embodiments the data layer comprises a biomechanical data model 210, a database 212, a solver 214, and data management components 216.

A tool layer 206 provides a suite of software tools to facilitate interaction with system users 20 via an Internet connection. Each of the software tools are modular, allowing functional elements to be easily incorporated into or removed from the system. In the embodiment of FIG. 10, the tool layer 206 comprises a database manipulation tool suite 218 for importing new data into the database 212, for performing queries to access data stored within the database 212, for reviewing data via three-dimensional representations, graphs, dynamic analyses (e.g., measuring dimensions, flow rates) and tabulating results, for performing side-by-side comparisons of patient data stored within the database 212 for multiple patients, and for performing statistical analyses to correlate medical records, risk factors, as well as other pre-determined or user-definable criteria.

A model assembly tool suite 220 provides a suite of software tools for building and refining biomechanics models for modeling medical procedures such as cardiovascular interventions or reconstructions. In some embodiments, the model assembly tool suite 220 provides functionality for selecting model inputs based on information within the database 212 and/or based on user imported data, for assembling graphical interaction models (e.g., a graphical model for selecting between different repair techniques based on three-dimensional vessel geometry), for automating the input of device types, materials, mechanical properties, rheological blood properties, flow properties, boundary conditions, and other input parameters from each of the evaluation modules, for selecting the size, location, and other characteristics of the device and/or the anatomy to be treated, and for performing finite element meshing.

An output visualization and analysis tool suite 222 provides a suite of software tools for visualizing and analyzing data. In some embodiments, the output visualization and analysis tool suite 222 provides functionality for visualizing static and dynamic mechanical data (e.g., three-dimensional pulsatile vessel deformations or velocities, blood flow, density/color mapping, stress/strain), for interactively performing graphical manipulation of data (e.g., rotation, zooming, panning, highlighting), for computing and mapping other mechanical factors onto three-dimensional vessel geometry (e.g., by interactive sliding thresholds, computation of maximum or minimum values, visualization of volumes over thresholds), for performing both quantitative and qualitative side-by-side comparisons of different medical procedures and potential outcomes, and for storing selected data outputs in the database 212 and exporting data in a user-defined format for later analysis.

An application programming interface (API) layer 208 provides a framework for the various software tools to communicate and exchange information through the Internet. The system architecture allows the various tool suites and other tools to be deployed across multiple, different platforms. In some embodiments, a centralized server architecture is used for performing resource-demanding graphical rendering and analysis. For Internet-based applications, a Representational State Transfer (REST) protocol, Simple Object Access Protocol (SOAP), or other suitable Web-services protocol 224 is used for exchanging information in the implementation of Web-based services.

FIG. 12 is a flow diagram showing an example method 226 for analyzing treatment outcomes in vascular interventions and reconstructions using the system 10 of FIG. 1. FIG. 12 may represent, for example, an example method for analyzing potential therapeutic outcomes in an endarterectomy procedure of a carotid artery using the system 10 of FIG. 1. As shown in FIG. 12, the method may begin generally at block 228 in which the user is prompted to input patient-specific data into the database for analysis. The patient data can include data obtained in-vivo from clinical measurements taken from the patient. The patient data can also include data such as the patient's age, gender, race, health condition, cardiac risk factor profile, as well as other patient-specific information. Once gathered, the patient specific data is then input to a database for later analysis (block 230).

At block 232, and in some embodiments, the user searches the database to obtain additional data to be associated with the patient based on patient data stored within the database. If, for example, patient-specific data at block 230 is not available, the data can be interpolated or extrapolated from the database based on other patient records that are searchable and stored within the database. For example, if data on blood viscosity is not readily available, it can be extrapolated from the database using viscosity data from patients with similar clinical records (e.g., blood count, stage of disease, lifestyle, risk factors, etc.).

The system next prompts the user to select treatment and/or medical device data to be associated with a proposed treatment option (block 234). The user then performs a search of the database and obtains model parameters to be associated with the biomechanical model (block 236). If, for example, the user desires to use finite element analysis to analyze the effects of pulsatile blood flow on an endarterectomized blood vessel, the user may select the model type from a display screen, and select from a number of finite element analysis options available for the modeling. An example finite element analysis model that can be used to evaluate endarterectomized and patched arteries is described, for example, in “Finite Element Model of the Patched Human Cartoid” published on Oct. 14, 2009 in the Journal of Vascular Endovascular Surgery, the contents of which are incorporated herein by reference in their entirety for all purposes.

From this information, the system then generates a coupled fluid-solid interaction biomechanical model and instructions (block 238) to be used for analyzing the inputs and model data. The biomechanical model and instructions can be construed in both the fluid and solid domains using an appropriate system of equations for each. A biomechanics simulation can then be performed (block 240) and an analysis performed on the biomechanics data (block 242). Based on the modeling preferences supplied to the biomechanical model, the processor analyzes the data supplied to the database from each of the evaluation modules to determine at least one potential treatment outcome using the biomechanical model. In some embodiments, the evaluation unit combines both measured and modeled data obtained across multiple modules to analyze potential treatment outcomes and to suggest potential treatment options available for treating the patient. In some embodiments, an optimization is performed on the biometrics data to optimize the proposed treatment option (block 244).

FIG. 13 is a flow diagram of another example method 248 for analyzing treatment outcomes in vascular interventions and reconstructions. FIG. 13 may represent, for example, an example implementation of the method 226 of FIG. 12 for analyzing potential therapeutic outcomes in an endarterectomy procedure using the system 10 of FIG. 1. As shown in FIG. 13, the method 248 may begin generally at block 250 in which patient-related data is acquired from one or more patients. In some embodiments, the process of acquiring patient data comprises acquiring geometry data associated with the vessel under evaluation (block 252), acquiring mechanical property data associated with the vessel (block 254), acquiring flow data associated with the flow characteristics of blood within the vessel (block 256), acquiring blood pressure data (block 258), and acquiring blood rheology data (260). Other physiological data can also be acquired from the patient.

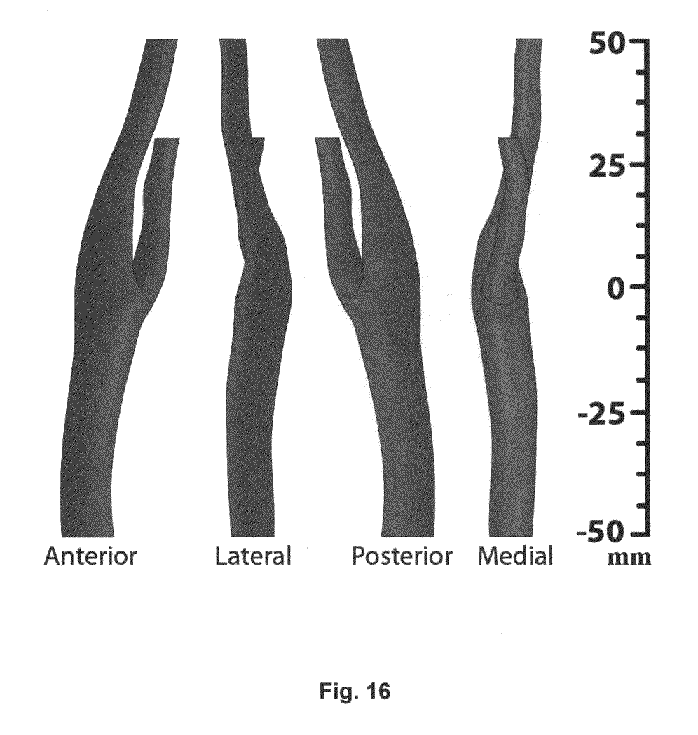

The process of acquiring geometry data at block 252 can be accomplished using MRI, CTA, invasive or non-invasive ultrasonography, and/or other suitable technique. In some embodiments, the three-dimensional geometry of the vessel under evaluation can be analyzed (block 262), providing the clinician with information such as the size, shape, tortuousness, and/or other geometrical characteristics of the vessel. An example of mean reconstructed arterial geometry from data obtained from sixteen patients is shown in FIG. 16.

The mechanical property data associated with the vessel can be acquired in-vitro, in-vivo, or using a combination of in-vitro and in-vivo techniques. For example, mechanical properties of patching materials that can be acquired in vitro using biaxial or tensile tests. Example of mechanical property data that can be acquired in-vivo comprises mechanical property data obtained using invasive and non-invasive ultrasonography and elastography. Based on these measurements, the mechanical properties of the vessel are obtained and constitutive models of the vessel are generated (block 264).

The process of acquiring flow data associated with the flow characteristics within the vessel at block 256 can be accomplished artificially using MRI or ultrasonography and/or in-vivo using MRI or invasive or non-invasive ultrasonography. Based on these measurements, flow velocity profiles associated with the vessel is generated (block 266).

The process of acquiring pressure data at block 258 can comprise measuring blood pressure using an invasive or non-invasive sensor, an angiocatheter, or other suitable technique. In some embodiments, the pressure measurements can be correlated with electrocardiogram measurements. Based on the sensed pressure data, a blood pressure waveform is generated (block 268).

The process of acquiring blood rheology data at block 260 can comprise measuring the blood composition, viscosity, shear rate, and/or other characteristics of the patient's blood. Based on these measurements, blood viscosity constitute laws are generated, which describe the blood viscosity characteristics of the patient's blood (block 260).

The three dimensional geometry data, mechanical properties and constitutive models, flow velocity profiles, pressure waveform data, and blood viscosity constitutive laws are stored within the database for further analysis by the evaluation unit (block 272). In some embodiments, information regarding the medical devices and materials available for repairing the blood vessel as well as disease growth and vessel remodeling constitutive laws are also supplied to the database for further analysis by the evaluation unit, as indicated generally at blocks 274 and 276, respectively.

Based on the data stored within the database, the evaluation unit is configured to generate inputs and interpolate model parameters to be used by the biomechanical model for analyzing the acquired patient data (block 278). From this data, and guided by user interaction (block 280), the system assembles a fluid/solid interaction model (block 282) that can be used to generate a proposed solution (block 284). In some embodiments, for example, the proposed solution generated by the model comprises the determination of which of the available medical devices and/or repair materials are optimal for a particular diseased vessel or patient condition. In another embodiment, the proposed solution generated by the model comprises the determination of a size or shape of a medical device (e.g., a stent) to be used in performing therapy on the patient. Other proposed solutions are also possible.

In some embodiments, post-processing and/or results mapping can be performed to confirm the efficacy of the proposed treatment and/or to further optimize the treatment (block 286). In certain embodiments, for example, results mapping can be performed over a three-dimensional blood vessel or two or three-dimensional sections of the vessel to determine and visualize locations of maximum or minimum values of particular factors, regions where factors exceed the set thresholds, stream/streak path lines on the plots, display plots of stress and strain, and/or viscosity, to perform queries for particular vessel zones, display dynamic graphs and three-dimensional plots, and generate area evolution graphs. Other post processing can also be performed on the data.

If at block 286, atherosclerosis potentially exists at the treatment site, the system can analyze the disease progression based on atherosclerosis growth models (block 290). If the analysis confirms that the disease will not grow or if further optimization is not desired or possible, then the system outputs a final result to the clinician (block 292). If, on the other hand, the disease is predicted to progress, the system performs additional treatment optimization (block 292). When the disease growth is predicted to terminate, the system outputs a final result (block 292) to the clinician.

In some embodiments, the system may perform an optimization on one or more criteria or goals (block 294), which can be automatically provided as input to the generation of input and interpolation of model parameters at block 278, or manually provided to the user. Examples of criteria or goals include the shape, size, type, location, and material. Such optimization can be performed at any time during the process, including at the post-processing and results mapping step (block 286), during visualization (block 290), and/or during the disease growth and remodeling step (block 292). The process of assembling the model, providing a proposed solution, and performing post-processing and results mapping can then be performed again based on the optimized data to obtain another result.

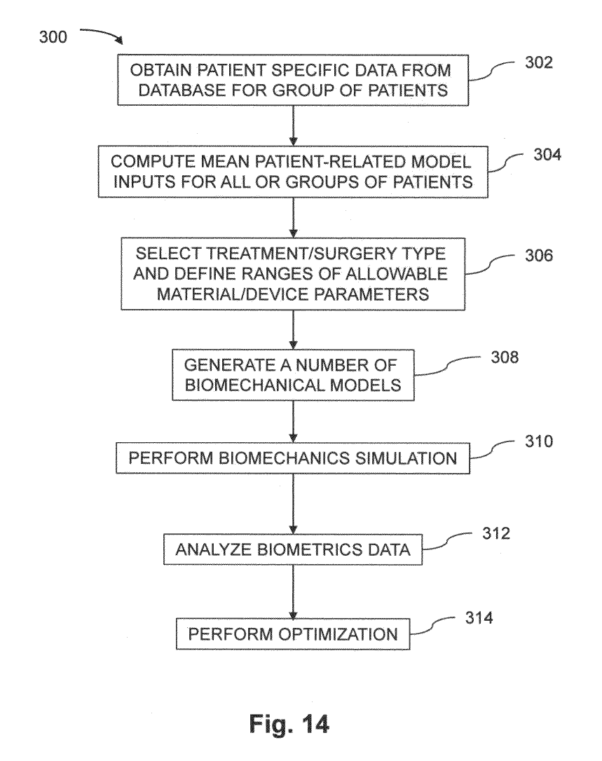

FIG. 14 is a flow diagram showing an example method 300 for developing a material or device design using the system 10 of FIG. 1. FIG. 14 may represent, for example, an example method for developing a stent or synthetic graft using the system 10 of FIG. 1. As shown in FIG. 14, the method may begin generally at block 302 in which the user obtains patient specific data from a database containing data for multiple patients. The patient data can include data obtained in-vivo from clinical measurements taken from the patient. The patient specific data can also be obtained in-vitro.

Based on the data stored in the database, the system next computes patient-related model inputs for all or groups of the patients (block 304). The system next prompts the user to select the treatment or surgery type and define ranges of allowable materials and/or device properties (block 306).

From this information, the system then generates one or more biomechanical models (block 308) to be used for analyzing the inputs and model data. A biomechanics simulation can then be performed (block 310) and an analysis performed on the biomechanics data (block 312). In some embodiments, an optimization is performed on the biometrics data to optimize the proposed treatment option (block 314).

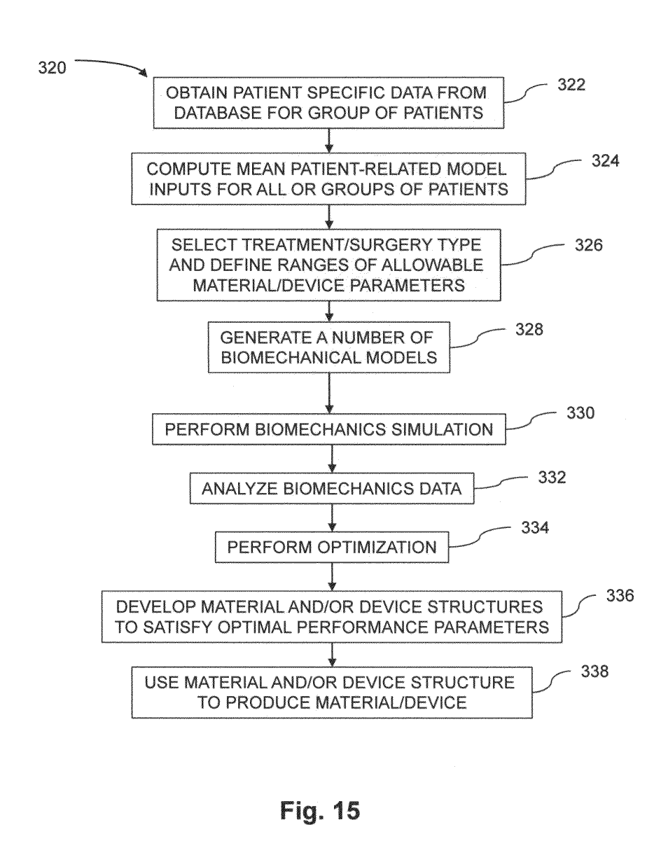

FIG. 15 is a flow diagram showing an example method 320 for developing a material or device design using the system 10 of FIG. 1. FIG. 15 may represent, for example, an example method for developing a stent or synthetic graft for a specific patient using the system 10 of FIG. 1. As shown in FIG. 15, the method may begin generally at block 322 in which the user obtains patient specific data from a database containing data for multiple patients. The patient data can include data obtained in-vivo from clinical measurements taken from the patient. The patient specific data can also be obtained in-vitro.

Based on the data stored in the database, the system next computes patient-related model inputs for all or groups of the patients (block 324). The system next prompts the user to select the treatment or surgery type and define ranges of allowable materials and/or device properties (block 326).

From this information, the system then generates one or more biomechanical models (block 328) to be used for analyzing the inputs and model data. A biomechanics simulation can then be performed (block 330) and an analysis performed on the biomechanics data (block 332). In some embodiments, an optimization is performed on the biometrics data to optimize the proposed treatment option (block 334). The optimization performance parameters that are obtained from the optimization are then used to develop the material and/or device structures (block 336). The materials and/or device structures are then used to produce the final material or device (block 338).

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What is claimed is:

1. A method for analyzing and predicting treatment outcomes of vascular interventions and reconstructions, comprising:
inputting patient specific data associated with a patient into a database;
searching the database and obtaining additional data to be associated with the patient, wherein the additional data is obtained based at least in part on patient specific data stored within the database for one or more other patients;
selecting at least one of a treatment parameter or medical device parameter to be used in association with a proposed treatment option for treating the patient;
searching the database and obtaining one or more model properties associated with the treatment or medical device parameter;
generating a fluid-solid interaction biomechanical model based at least in part on the patient specific data, the additional data associated with the patient, and the model properties;
performing a biomechanics simulation and generating biomechanics data using the biomechanical model; and
analyzing the biomechanics data.

2. The method of claim 1, wherein the patient specific data for the patient comprises data selected from the group of data comprising age, gender, race, risk factor profile, clinical history, medications, blood count, diet, and lifestyle.

3. The method of claim 1, wherein the patient specific data for the patient includes three-dimensional vessel geometry properties.

4. The method of claim 1, wherein the patient specific data for the patient comprises data selected from the group of properties comprising vessel wall tissue mechanical properties and blood rheologic properties.

5. The method of claim 1, wherein the patient specific data for the patient comprises data selected from the group of properties comprising dynamic blood flow properties, blood pressure cycles, and boundary conditions.

6. The method of claim 1, wherein the patient specific data and model properties associated with the treatment or method are obtained using a plurality of input evaluation modules.

7. The method of claim 6, wherein the plurality of input evaluation modules are selected from the group of modules comprising a mechanical properties evaluation module, a blood rheology evaluation module, a blood vessel geometry evaluation module, a medical device geometry evaluation module, a boundary blood flow evaluation module, and a load evaluation module.

8. The method of claim 1, wherein the additional data to be associated with the patient is selected from the database of data for other patients based on clinical data for the patient.

9. The method of claim 8, wherein the clinical data for the patient is selected from the group of data comprising patient age, gender, race, risk factors, clinical history, medications, diet, lifestyle and pregnancy.

10. The method of claim 8, wherein the clinical information for the patient includes laboratory or in-vivo tests on the patient.

11. The method of claim 1, wherein selection of the treatment parameter or medical device parameter comprises selecting at least one parameter from the group of parameters comprising a type of surgery or intervention, the type of medical device, the geometry of the medical device, the material of the medical device, and the mechanical properties of the medical device.

12. The method of claim 1, wherein generating the fluid-solid interaction biomechanical model comprises generating an algorithm for solving time-dependent, three-dimensional solid and fluid biomechanics equations with boundary conditions based on the patient specific and additional data associated with the patient and model properties associated with the treatment or medical device parameter.

13. The method of claim 12, wherein generating the biomechanics data comprises generating at least one output selected from the group of outputs comprising a time-dependent, three-dimensional distributions of stresses and strains within a vessel wall or medical device, time-dependent, three-dimensional distributions of blood velocities, pressure, and flow shear stresses in blood.

14. The method of claim 1, further comprising analyzing one or more derivative parameters associated with the biomechanics data.

15. The method of claim 14, wherein the one or more derivative parameters comprises at least one derivative parameter selected from the group of parameters comprising atherosclerosis-related parameters, restenosis prediction parameters, and device mechanical failure parameters.

16. The method of claim 14, wherein the derivative parameters are obtained by quantitatively and qualitatively analyzing the biomechanics data.

17. The method of claim 14, wherein the derivative parameters are obtained by static or dynamic visualization and mapping.

18. The method of claim 1, further comprising generating and repeatedly updating the fluid-solid interaction biomechanical model, performing a biomechanics simulation, generating biomechanics data, and analyzing the simulation and biomechanics data to optimize the proposed treatment option.

19. The method of claim 1, further comprising computing mean patient data based on patient data for a plurality of patients.

20. A method for analyzing and predicting treatment outcomes of vascular interventions and reconstructions, comprising:
obtaining, in vivo, patient specific data associated with a patient;
searching a database and obtaining additional data to be associated with the patient, wherein the database is configured to classify and stored data for a plurality of patients, and wherein the additional data is obtained based at least in part on patient specific data stored within the database for one or more other patients;
selecting at least one of a treatment parameter or medical device parameter to be used in association with a proposed treatment option for treating the patient;
searching the database and obtaining one or more model properties associated with the treatment parameter or medical device parameter;
generating a fluid-solid interaction biomechanical model based at least in part on the patient specific data, the additional data associated with the patient, and the model properties, wherein the fluid-solid interaction biomechanical model comprises time-dependent, three-dimensional solid and fluid equations;
performing a biomechanics simulation and generating biomechanics data using the biomechanical model; and
analyzing the biomechanics data and determining the effectiveness of the proposed treatment.

21. A system for analyzing and predicting therapeutic outcomes in medical procedures, comprising:
a relational database configured for classifying and storing patient specific input data for a plurality of patients;
a means for obtaining and inputting patient specific input data to the database;
a means for selecting additional data to be associated with the patient in the database;
a means for inputting treatment related and medical device related parameters to the database;
a means for selecting treatment type, inputting model parameters, and assembling a biomechanical model based on the selected treatment type, the patient specific data, the additional data associated with the patient, and the treatment and medical device related parameters;
a processor and fluid-solid interaction biomechanical model configured for performing a biomechanics simulation and generating biomechanics data, the fluid-solid biomechanical model comprising time-dependent, three-dimensional solid and fluid equations;
a means for evaluating the outcomes of the biomechanics simulation; and
an interface configured for exchanging data between the database and a plurality of users.

22. The system of claim 21, wherein said means for gathering input data comprises a plurality of input evaluation modules.

23. The system of claim 22, wherein the plurality of evaluation modules are selected from the group of modules comprising a mechanical properties evaluation module, a blood rheology evaluation module, a blood vessel geometry evaluation module, a medical device geometry evaluation module, a boundary blood flow evaluation module, and a load evaluation module.

24. The system of claim 22, wherein the plurality of evaluation modules further comprises a restenosis prediction module.

25. The system of claim 22, wherein the plurality of evaluation modules further comprises a failure prediction module.

26. The system of claim 22, wherein the plurality of evaluation modules further comprises a treatment selection and optimization module.

27. The system of claim 22, wherein the plurality of evaluation modules further comprises a design evaluation module.
